(19) United States
(12) Patent Application Publication
(10) Pub. No.: US 2025/0272559 A1
(43) Pub. Date: Aug. 28, 2025

(54) COMMUNICATION METHOD AND RELATED APPARATUS

(71) Applicant: HUAWEI TECHNOLOGIES CO., LTD., Shenzhen (CN)

(72) Inventors: Fei WANG, Shanghai (CN); Chenghui PENG, Shanghai (CN); Zhe LIU, Shanghai (CN); Jun WANG, Shanghai (CN); Jianjun WU, Shenzhen (CN)

(21) Appl. No.: 19/208,905

(22) Filed: May 15, 2025

Related U.S. Application Data
(63) Continuation of application No. PCT/CN2022/132135, filed on Nov. 16, 2022.

(51) Int. Cl. G06N 3/08

(52) U.S. Cl. CPC G06N 3/08

(57) ABSTRACT

Embodiments of this disclosure provide a communication method and a related apparatus, to reduce signaling overheads of sending a local model parameter of a first model by a first apparatus. The first apparatus receives first information from a second apparatus, where the first information indicates whether the first apparatus sends each local model parameter of the first model of the first apparatus. The first apparatus determines a part of to-be-sent local model parameters of the first model based on the first information, where the part of the local model parameters is obtained by training the first model. The first apparatus sends the part of the local model parameters to the second apparatus.

### CROSS-REFERENCE TO RELATED APPLICATIONS

This application is a continuation of International Application No. PCT/CN2022/132135, filed on Nov. 16, 2022, the disclosure of which is hereby incorporated by reference in its entirety.

### TECHNICAL FIELD

This disclosure relates to the field of communication technologies, and in particular, to a communication method and a related apparatus.

### BACKGROUND

For a 5th generation (5G) mobile communication system network, research starts from Release 16 R16) to support an artificial intelligence (AI) function in the 5G network via a network data analytics function (NWDAF) network element. The NWDAF network element is mainly configured to: collect and analyze data at an application layer, and externally provide a service and an interface for invoking. In R18, there is a research topic on function extension of the NWDAF network element, to provide support for an AI service externally, perform model transmission in a network, and the like.

A combination of AI and a network is an important direction of future research. Transmission of a large quantity of related parameters of a model needs to be performed over the network. As a scale of the model becomes larger, there are more related parameters of the model. In this case, in a wireless network, transmission of the related parameters of the model causes huge signaling overheads. Therefore, how to reduce signaling overheads of transmission of the related parameters of the model between devices is a problem worth considering.

### SUMMARY

This disclosure provides a communication method and a related apparatus, to reduce signaling overheads of sending a local model parameter of a first model by a first apparatus.

A first aspect of this disclosure provides a communication method, including:

A first apparatus receives first information from a second apparatus, where the first information indicates whether the first apparatus sends each local model parameter of a first model of the first apparatus. The first apparatus determines a part of to-be-sent local model parameters of the first model based on the first information, where the part of the local model parameters is obtained by training the first model. The first apparatus sends the part of the local model parameters to the second apparatus.

It can be learned from the foregoing technical solution that the first apparatus may determine the part of the local model parameters of the first model based on the first information. Then, the first apparatus sends the part of the local model parameters of the first model to the second apparatus. The first apparatus does not need to send all the local model parameters of the first model. Therefore, signaling overheads of reporting a local model parameter of the first model by the first apparatus are reduced. Further, the first apparatus may calculate only the part of the local model parameters of the first model, and does not need to calculate a local model parameter that is of the first model and that does not need to be sent. Therefore, a calculation amount of the first apparatus is reduced, and an energy consumption loss of the first apparatus is reduced.

A second aspect of this disclosure provides a communication method, including:

A second apparatus sends first information to a first apparatus, where the first information indicates whether the first apparatus sends each local model parameter of a first model of the first apparatus. The second apparatus receives a part of local model parameters of the first model from the first apparatus, where the part of the local model parameters is obtained by training the first model.

It can be learned from the foregoing technical solution that the second apparatus may send the first information to the first apparatus, to indicate the first apparatus to send the part of the local model parameters of the first model of the first apparatus. The first apparatus may send the part of the local model parameters of the first model to the second apparatus. The first apparatus does not need to send all the local model parameters of the first model. Therefore, signaling overheads of reporting a local model parameter of the first model by the first apparatus are reduced. Further, the first apparatus may calculate only the part of the local model parameters of the first model, and does not need to calculate a local model parameter that is of the first model and that does not need to be sent. Therefore, a calculation amount of the first apparatus is reduced, and an energy consumption loss of the first apparatus is reduced.

Based on the first aspect or the second aspect, in a possible implementation, the local model parameter includes a local weight parameter of the first model. In this implementation, a specific form of the local model parameter is shown. Transmission of the local weight parameter of the first model is performed between the first apparatus and the second apparatus according to the technical solution of this disclosure. This reduces overheads produced during the transmission of the local weight parameter between the first apparatus and the second apparatus.

Based on the first aspect or the second aspect, in a possible implementation, the local weight parameter includes a local weight or a local weight gradient of the first model.

Based on the first aspect or the second aspect, in a possible implementation, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus sends the local model parameter.

In this implementation, the first information includes the N pieces of first indication information, and the N pieces of first indication information are in one-to-one correspondence with the N local model parameters. In this way, each piece of first indication information indicates whether the first apparatus sends a local model parameter corresponding to the first indication information.

Based on the first aspect or the second aspect, in a possible implementation, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter.

In this implementation, the first information includes the P pieces of second indication information, and the P pieces of second indication information are in one-to-one correspondence with the local model parameters of the P layers of neurons. Therefore, each piece of second indication information indicates whether the first apparatus sends a local model parameter that is of a layer of neurons and that corresponds to the second indication information. Further, in this implementation, the second apparatus indicates, by using a layer as a granularity, whether the first apparatus sends the local model parameter of each layer of neurons. This helps reduce overheads produced when the second apparatus sends the first information.

Based on the first aspect, in a possible implementation, the method further includes: The first apparatus receives N global model parameters of the first model or global model parameters of the P layers of neurons of the first model from the second apparatus.

In this implementation, the first apparatus may receive the N global model parameters of the first model or the global model parameters of the P layers of neurons. Therefore, the first apparatus updates the first model with reference to the N global model parameters of the first model or the global model parameters of the P layers of neurons.

Based on the second aspect, in a possible implementation, the method further includes: The second apparatus sends the N global model parameters of the first model or the global model parameters of the P layers of neurons of the first model to the first apparatus.

In this implementation, the second apparatus may send the N global model parameters of the first model or the global model parameters of the P layers of neurons of the first model to the first apparatus. Therefore, the first apparatus updates the first model with reference to the N global model parameters of the first model or the global model parameters of the P layers of neurons.

Based on the first aspect or the second aspect, in a possible implementation, the N global model parameters are in one-to-one correspondence with the N local model parameters; the N pieces of first indication information and the N global model parameters are carried in same signaling or different signaling; and when the N pieces of first indication information and the N global model parameters are carried in the same signaling, the N global model parameters and the N pieces of first indication information are arranged at intervals, and first indication information corresponding to each global model parameter is adjacently arranged after the global model parameter, or the N global model parameters are arranged before the N pieces of first indication information.

In this implementation, the N global model parameters and the N local model parameters may be carried in the same signaling or different signaling. For a case in which the N global model parameters and the N local model parameters are carried in the same signaling, two formats of the N global model parameters and the N local model parameters in the signaling are shown.

Based on the first aspect or the second aspect, in a possible implementation, the global model parameters of the P layers of neurons are in one-to-one correspondence with the local model parameters of the P layers of neurons; the P pieces of second indication information and the global model parameters of the P layers of neurons are carried in same signaling or different signaling; and when the P pieces of second indication information and the global model parameters of the P layers of neurons are carried in the same signaling, the global model parameters of the P layers of neurons and the P pieces of second indication information are arranged at intervals, and second indication information corresponding to a global model parameter of each layer of neurons is adjacently arranged after the global model parameter of each layer of neurons, or the global model parameters of the P layers of neurons are arranged before the P pieces of second indication information.

In this implementation, the P pieces of second indication information and the global model parameters of the P layers of neurons may be carried in the same signaling or different signaling. For a case in which the P pieces of second indication information and the global model parameters of the P layers of neurons are carried in the same signaling, two formats of the P pieces of second indication information and the global model parameters of the P layers of neurons in the signaling are shown.

Based on the first aspect or the second aspect, in a possible implementation, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates the first apparatus not to send a local model parameter of a neuron of the at least one first target layer; or the first information includes a second flag bit and a layer sequence number of at least one second target layer in the P layers of neurons, and the second flag bit indicates the first apparatus to send a local model parameter of a neuron of the at least one second target layer.

In this implementation, the first information includes the first flag bit and the layer sequence number of the at least one first target layer in the P layers of neurons. The first flag bit uniformly indicates the first apparatus not to send the local model parameter of a neuron of the at least one first target layer. Therefore, indication overheads of the second apparatus are reduced. For a scenario in which there are a small quantity of first target layers, the second apparatus may send the first information in this implementation, to help further reduce the indication overheads. Alternatively, the first information includes the second flag bit and the layer sequence number of the at least one second target layer in the P layers of neurons. The second flag bit uniformly indicates the first apparatus to send the local model parameter of a neuron of the at least one second target layer. Therefore, indication overheads of the second apparatus are reduced. For a scenario in which there are a small quantity of second target layers, the second apparatus may send the first information in this implementation, to help further reduce the indication overheads.

A third aspect of this disclosure provides a communication method, including:

A first apparatus determines a part of to-be-sent local model parameters of a first model of the first apparatus, where the part of the local model parameters is obtained by training the first model. The first apparatus sends the part of the local model parameters and first information to a second apparatus, where the first information indicates that the first apparatus has sent the part of the local model parameters.

It can be learned from the foregoing technical solution that the first apparatus may determine the part of to-be-sent the local model parameters of the first model. Then, the first apparatus sends the part of the local model parameters of the first model and the first information to the second apparatus. The first information indicates that the first apparatus has sent the part of the local model parameters of the first model. It can be learned that the first apparatus may send only the part of the local model parameters of the first model, and the first apparatus does not need to send all the local model parameters of the first model. Therefore, signaling overheads of sending a local model parameter of the first model by the first apparatus are reduced. Further, the first apparatus may calculate only the part of the local model parameters of the first model, and does not need to calculate a local model parameter that is of the first model and that does not need to be sent. Therefore, a calculation amount of the first apparatus is reduced, and an energy consumption loss of the first apparatus is reduced.

A fourth aspect of this disclosure provides a communication method, including:

A second apparatus receives a part of local model parameters of a first model and first information from a first apparatus, where the first information indicates that the first apparatus has sent the part of the local model parameters, and the part of the local model parameters is obtained by training the first model. The second apparatus determines the part of the local model parameters based on the first information.

It can be learned from the foregoing technical solution that the second apparatus receives the part of the local model parameters of the first model and the first information from the first apparatus. It can be learned that the first apparatus may send only the part of the local model parameters of the first model, and the first apparatus does not need to send all the local model parameters of the first model. Therefore, signaling overheads of sending a local model parameter of the first model by the first apparatus are reduced. Further, the first apparatus may calculate only the part of the local model parameters of the first model, and does not need to calculate a local model parameter that is of the first model and that does not need to be sent. Therefore, a calculation amount of the first apparatus is reduced, and an energy consumption loss of the first apparatus is reduced.

Based on the third aspect or the fourth aspect, in a possible implementation, the part of the local model parameters includes a local weight parameter of the first model. In this implementation, a specific form of the local model parameter is shown. Transmission of the local weight parameter of the first model is performed between the first apparatus and the second apparatus according to the technical solution of this disclosure. This reduces overheads produced during the transmission of the local weight parameter between the first apparatus and the second apparatus.

Based on the third aspect or the fourth aspect, in a possible implementation, the local weight parameter includes a local weight or a local weight gradient of the first model.

Based on the third aspect or the fourth aspect, in a possible implementation, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus sends the local model parameter.

In this implementation, the first information includes the N pieces of first indication information, and the N pieces of first indication information are in one-to-one correspondence with the N local model parameters. In this way, each piece of first indication information indicates whether the first apparatus sends a local model parameter corresponding to the first indication information.

Based on the third aspect or the fourth aspect, in a possible implementation, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter of the layer of neurons.

In this implementation, the first information includes the P pieces of second indication information, and the P pieces of second indication information are in one-to-one correspondence with the local model parameters of the P layers of neurons. Therefore, each piece of second indication information indicates whether the first apparatus sends a local model parameter that is of a layer of neurons and that corresponds to the second indication information. Further, in this implementation, the second apparatus indicates, by using a layer as a granularity, whether the first apparatus sends the local model parameter of each layer of neurons. This helps reduce overheads produced when the second apparatus sends the first information.

Based on the third aspect or the fourth aspect, in a possible implementation, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates that the first apparatus has not sent a local model parameter of a neuron of the at least one first target layer; or the first information includes a second flag bit and a layer sequence number of at least one second target layer in the P layers of neurons, and the second flag bit indicates that the first apparatus has sent a local model parameter of a neuron of the at least one second target layer.

In this implementation, the first information includes the first flag bit and the layer sequence number of the at least one first target layer in the P layers of neurons. The first flag bit uniformly indicates the first apparatus not to send the local model parameter of a neuron of the at least one first target layer. Therefore, indication overheads of the first apparatus are reduced. For a scenario in which there are a small quantity of first target layers, the first apparatus may send the first information in this implementation, to help further reduce the indication overheads. Alternatively, the first information includes the second flag bit and the layer sequence number of the at least one second target layer in the P layers of neurons. The second flag bit uniformly indicates the first apparatus to send the local model parameter of a neuron of the at least one second target layer. Therefore, indication overheads of the first apparatus are reduced. For a scenario in which there are a small quantity of second target layers, the first apparatus may send the first information in this implementation, to help further reduce the indication overheads.

Based on the third aspect, in a possible implementation, that a first apparatus determines a part of to-be-sent local model parameters of a first model of the first apparatus includes: The first apparatus determines the part of the local model parameters based on at least one of the following: a local model parameter obtained by the first apparatus by performing an R^{th} round of training on the first model, a status of a communication link on which the first apparatus is located, and an operation capability of the first apparatus, where the part of the local model parameters is obtained by the first apparatus by performing an (R+1)^{th} round of training on the first model, and R is an integer greater than or equal to 1.

In this implementation, a possible implementation in which the first apparatus determines the part of to-be-sent the local model parameters of the first model is shown. In this way, the first apparatus properly determines the part of to-be-sent the local model parameters, and reports an important local model parameter to the second apparatus as much as possible, so that overheads of reporting a local model parameter by the first apparatus are reduced without affecting accuracy of a global model parameter determined by the second apparatus.

A fifth aspect of this disclosure provides a communication method, including:

A first apparatus receives a part of first global model parameters of a first model of the first apparatus from a second apparatus. The first apparatus receives first information from the second apparatus, where the first information indicates that the second apparatus has sent the part of the first global model parameters.

The first apparatus updates the first model based on the first information and the part of the first global model parameters, to obtain an updated first model.

In the foregoing technical solution, the first apparatus may receive the part of the first global model parameters of the first model and the first information. Then, the first apparatus updates the first model based on the first information and the part of the first global model parameters, to obtain the updated first model. It can be learned that the second apparatus may send only the part of the first global model parameters of the first model, and does not need to send all the first global model parameters of the first model to the first apparatus. Therefore, overheads of sending a first global model parameter by the second apparatus are reduced.

A sixth aspect of this disclosure provides a communication method, including:

A second apparatus sends a part of first global model parameters of a first model of a first apparatus to the first apparatus. The second apparatus sends first information to the first apparatus, where the first information indicates that the second apparatus has sent the part of the first global model parameters.

In the foregoing technical solution, the second apparatus sends the part of the first global model parameters of the first model of the first apparatus and the first information to the first apparatus. In this way, the first apparatus updates the first model based on the first information and the part of the first global model parameters, to obtain an updated first model. The second apparatus may send only the part of the first global model parameters of the first model, and does not need to send all the first global model parameters of the first model to the first apparatus. Therefore, overheads of sending a first global model parameter by the second apparatus are reduced.

Based on the fifth aspect or the sixth aspect, in a possible implementation, the part of the first global model parameters includes a global weight parameter of the first model. In this implementation, a specific form of the first global model parameter is shown. Transmission of the global weight parameter of the first model is performed between the first apparatus and the second apparatus according to the technical solution of this disclosure. This reduces overheads produced during the transmission of the global weight parameter between the first apparatus and the second apparatus.

Based on the fifth aspect or the sixth aspect, in a possible implementation, the global weight parameter includes a global weight or a global weight gradient of the first model.

Based on the fifth aspect or the sixth aspect, in a possible implementation, all the first global model parameters of the first model include N first global model parameters, N is an integer greater than or equal to 2, the first information includes N pieces of first indication information, the N pieces of first indication information are in one-to-one correspondence with the N first global model parameters, and first indication information corresponding to each of the N first global model parameters indicates whether the second apparatus sends the first global model parameter.

In this implementation, the first information includes the N pieces of first indication information, and the N pieces of first indication information are in one-to-one correspondence with the N first global model parameters. Therefore, the first indication information corresponding to each of the N first global model parameters indicates whether the second apparatus sends the first global model parameter.

Based on the fifth aspect or the sixth aspect, in a possible implementation, all the first global model parameters of the first model include first global model parameters of P layers of neurons, P is an integer greater than or equal to 1, the first information includes P pieces of second indication information, the P pieces of second indication information are in one-to-one correspondence with the first global model parameters of the P layers of neurons, and second indication information corresponding to a first global model parameter of each of the P layers of neurons indicates whether the second apparatus sends the first global model parameter of each layer of neurons.

In this implementation, the first information includes the P pieces of second indication information, and the P pieces of second indication information are in one-to-one correspondence with the first global model parameters of the P layers of neurons. In this way, each piece of second indication information indicates whether the first apparatus sends a first global model parameter that is of a layer of neurons and that corresponds to the second indication information. Further, in this implementation, the second apparatus indicates, by using a layer as a granularity, whether the second apparatus sends the first global model parameter of each layer of neurons. This helps reduce overheads produced when the second apparatus sends the first information.

Based on the fifth aspect or the sixth aspect, in a possible implementation, all the first global model parameters of the first model include first global model parameters of P layers of neurons, and P is an integer greater than or equal to 1; and
the first information includes a first flag bit and a layer sequence number of at least one first target layer in the P layers of neurons, and the first flag bit indicates that the second apparatus has not sent a first global model parameter of a neuron of the at least one first target layer; or
the first information includes a second flag bit and a layer sequence number of at least one second target layer in the P layers of neurons, and the second flag bit indicates that the second apparatus has sent a first global model parameter of a neuron of the at least one second target layer.

In this implementation, the first information includes the first flag bit and the layer sequence number of the at least one first target layer in the P layers of neurons. The first flag bit uniformly indicates the second apparatus not to send the first global model parameter of a neuron of the at least one first target layer. Therefore, indication overheads of the second apparatus are reduced. For a scenario in which there are a small quantity of first target layers, the second apparatus may send the first information in this implementation, to help further reduce the indication overheads. Alternatively, the first information includes the second flag bit and the layer sequence number of the at least one second target layer in the P layers of neurons. The second flag bit uniformly indicates the second apparatus to send the first global model parameter of a neuron of the at least one second target layer. Therefore, indication overheads of the second apparatus are reduced. For a scenario in which there are a small quantity of second target layers, the second apparatus may send the first information in this implementation, to help further reduce the indication overheads.

Based on the fifth aspect or the sixth aspect, in a possible implementation, all the first global model parameters of the first model include N first global model parameters obtained by the second apparatus by aggregating local model parameters of a plurality of apparatuses in an (M+1)^{th} round, and N is an integer greater than or equal to 2; the N first global model parameters are in one-to-one correspondence with N second global model parameters, the N second global model parameters are obtained by the second apparatus by aggregating local model parameters of the plurality of apparatuses in an M^{th} round, and M is an integer greater than or equal to 1; and in the part of the first global model parameters, a ratio of a variation between each first global model parameter and a second global model parameter corresponding to the first global model parameter to the second global model parameter is greater than a first ratio. In this implementation, the second apparatus may send, to the first apparatus, a first global model parameter with a relatively large variation, and may discard a first global model parameter with a relatively small variation. In this way, accuracy of updating the first model by the first apparatus is not affected, and reporting overheads of a model parameter can be further reduced.

A seventh aspect of this disclosure provides a first apparatus, including:
a transceiver module, configured to receive first information from a second apparatus, where the first information indicates whether the first apparatus sends each local model parameter of a first model of the first apparatus; and
a processing module, configured to determine a part of to-be-sent local model parameters of the first model based on the first information, where the part of the local model parameters is obtained by training the first model.

The transceiver module is further configured to send the part of the local model parameters to the second apparatus.

An eighth aspect of this disclosure provides a second apparatus, including:
a transceiver module, configured to: send first information to a first apparatus, where the first information indicates whether the first apparatus sends each local model parameter of a first model of the first apparatus; and receive a part of local model parameters of the first model from the first apparatus, where the part of the local model parameters is obtained by training the first model.

Based on the seventh aspect or the eighth aspect, in a possible implementation, the local model parameter includes a local weight parameter of the first model.

Based on the seventh aspect or the eighth aspect, in a possible implementation, the local weight parameter includes a local weight or a local weight gradient of the first model.

Based on the seventh aspect or the eighth aspect, in a possible implementation, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus sends the local model parameter.

Based on the seventh aspect or the eighth aspect, in a possible implementation, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter.

Based on the seventh aspect, in a possible implementation, the transceiver module is further configured to receive N global model parameters of the first model or global model parameters of the P layers of neurons of the first model from the second apparatus.

Based on the eighth aspect, in a possible implementation, the transceiver module is further configured to send N global model parameters of the first model or global model parameters of the P layers of neurons of the first model to the first apparatus.

Based on the seventh aspect or the eighth aspect, in a possible implementation, the N global model parameters are in one-to-one correspondence with the N local model parameters; the N pieces of first indication information and the N global model parameters are carried in same signaling or different signaling; and when the N pieces of first indication information and the N global model parameters are carried in the same signaling, the N global model parameters and the N pieces of first indication information are arranged at intervals, and first indication information corresponding to each global model parameter is adjacently arranged after the global model parameter, or the N global model parameters are arranged before the N pieces of first indication information.

Based on the seventh aspect or the eighth aspect, in a possible implementation, the global model parameters of the P layers of neurons are in one-to-one correspondence with the local model parameters of the P layers of neurons; the P pieces of second indication information and the global model parameters of the P layers of neurons are carried in same signaling or different signaling; and when the P pieces of second indication information and the global model parameters of the P layers of neurons are carried in the same signaling, the global model parameters of the P layers of neurons and the P pieces of second indication information are arranged at intervals, and second indication information corresponding to a global model parameter of each layer of neurons is adjacently arranged after the global model parameter of each layer of neurons, or the global model parameters of the P layers of neurons are arranged before the P pieces of second indication information. In addition, a spacing between the global model parameter of each layer of neurons and the second indication information corresponding to the global model parameter of each layer of neurons is equal. Alternatively, the P pieces of second indication information and the global model parameters of the P layers of neurons are carried in different signaling.

Based on the seventh aspect or the eighth aspect, in a possible implementation, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates the first apparatus not to send a local model parameter of a neuron of the at least one first target layer; or the first information includes a second flag bit and a layer sequence number of at least one second target layer in the P layers of neurons, and the second flag bit indicates the first apparatus to send a local model parameter of a neuron of the at least one second target layer.

A ninth aspect of this disclosure provides a first apparatus, including:
a processing module, configured to determine a part of to-be-sent local model parameters of a first model of the first apparatus, where the part of the local model parameters is obtained by training the first model; and
a transceiver module, configured to send the part of the local model parameters and first information to a second apparatus, where the first information indicates that the first apparatus has sent the part of the local model parameters.

A tenth aspect of this disclosure provides a second apparatus, including:
a transceiver module, configured to receive a part of local model parameters of a first model and first information from a first apparatus, where the first information indicates that the first apparatus has sent the part of the local model parameters, and the part of the local model parameters is obtained by training the first model; and
a processing module, configured to determine the part of the local model parameters based on the first information.

Based on the ninth aspect or the tenth aspect, in a possible implementation, the part of the local model parameters includes a local weight parameter of the first model.

Based on the ninth aspect or the tenth aspect, in a possible implementation, the local weight parameter includes a local weight or a local weight gradient of the first model.

Based on the ninth aspect or the tenth aspect, in a possible implementation, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus sends the local model parameter.

Based on the ninth aspect or the tenth aspect, in a possible implementation, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter of the layer of neurons.

Based on the ninth aspect or the tenth aspect, in a possible implementation, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates that the first apparatus has not sent a local model parameter of a neuron of the at least one first target layer; or the first information includes a second flag bit and a layer sequence number of at least one second target layer in the P layers of neurons, and the second flag bit indicates that the first apparatus has sent a local model parameter of a neuron of the at least one second target layer.

Based on the ninth aspect, in a possible implementation, the processing module is specifically configured to determine the part of the local model parameters based on at least one of the following: a local model parameter obtained by the first apparatus by performing an R^{th} round of training on the first model, a status of a communication link on which the first apparatus is located, and an operation capability of the first apparatus, where the part of the local model parameters is obtained by the first apparatus by performing an (R+1)^{th} round of training on the first model, and R is an integer greater than or equal to 1.

An eleventh aspect of this disclosure provides a first apparatus, including:
a transceiver module, configured to: receive a part of first global model parameters of a first model of the first apparatus from a second apparatus; and receive first information from the second apparatus, where the first information indicates that the second apparatus has sent the part of the first global model parameters; and
a processing module, configured to update the first model based on the first information and the part of the first global model parameters, to obtain an updated first model.

A twelfth aspect of this disclosure provides a second apparatus, including:
a transceiver module, configured to: send a part of first global model parameters of a first model of a first apparatus to the first apparatus; and send first information to the first apparatus, where the first information indicates that the second apparatus has sent the part of the first global model parameters.

Based on the eleventh aspect or the twelfth aspect, in a possible implementation, the part of the first global model parameters includes a global weight parameter of the first model.

Based on the eleventh aspect or the twelfth aspect, in a possible implementation, the global weight parameter includes a global weight or a global weight gradient of the first model.

Based on the eleventh aspect or the twelfth aspect, in a possible implementation, all the first global model parameters of the first model include N first global model parameters, N is an integer greater than or equal to 2, the first information includes N pieces of first indication information, the N pieces of first indication information are in one-to-one correspondence with the N first global model parameters, and first indication information corresponding to each of the N first global model parameters indicates whether the second apparatus sends the first global model parameter.

Based on the eleventh aspect or the twelfth aspect, in a possible implementation, all the first global model parameters of the first model include first global model parameters of P layers of neurons, P is an integer greater than or equal to 1, the first information includes P pieces of second indication information, the P pieces of second indication information are in one-to-one correspondence with the first global model parameters of the P layers of neurons, and second indication information corresponding to a first global model parameter of each of the P layers of neurons indicates whether the second apparatus sends the first global model parameter of each layer of neurons.

Based on the eleventh aspect or the twelfth aspect, in a possible implementation, all the first global model parameters of the first model include first global model parameters of P layers of neurons, and P is an integer greater than or equal to 1; and
the first information includes a first flag bit and a layer sequence number of at least one first target layer in the P layers of neurons, and the first flag bit indicates that the second apparatus has not sent a first global model parameter of a neuron of the at least one first target layer; or
the first information includes a second flag bit and a layer sequence number of at least one second target layer in the P layers of neurons, and the second flag bit indicates that the second apparatus has sent a first global model parameter of a neuron of the at least one second target layer.

Based on the eleventh aspect or the twelfth aspect, in a possible implementation, all the first global model parameters of the first model include N first global model parameters obtained by the second apparatus by aggregating local model parameters of a plurality of apparatuses in an (M+1)^{th} round, and N is an integer greater than or equal to 2; the N first global model parameters are in one-to-one correspondence with N second global model parameters, the N second global model parameters are obtained by the second apparatus by aggregating local model parameters of the plurality of apparatuses in an M^{th} round, and M is an integer greater than or equal to 1; and in the part of the first global model parameters, a ratio of a variation between each first global model parameter and a second global model parameter corresponding to the first global model parameter to the second global model parameter is greater than a first ratio.

A thirteenth aspect of this disclosure provides a first apparatus. The first apparatus includes a processor and a memory. The memory stores a computer program or computer instructions, and the processor is configured to invoke and run the computer program or the computer instructions stored in the memory, to enable the processor to implement any one of the implementations of the first aspect, the third aspect, and the fifth aspect.

Optionally, the first apparatus further includes a transceiver, and the processor is configured to control the transceiver to receive or send a signal.

A fourteenth aspect of this disclosure provides a second apparatus. The second apparatus includes a processor and a memory. The memory stores a computer program or computer instructions, and the processor is configured to invoke and run the computer program or the computer instructions stored in the memory, to enable the processor to implement any one of the implementations of the second aspect, the fourth aspect, and the sixth aspect.

Optionally, the second apparatus further includes a transceiver, and the processor is configured to control the transceiver to receive or send a signal.

A fifteenth aspect of this disclosure provides a first apparatus, including a processor and an interface circuit. The processor is configured to: communicate with another apparatus through the interface circuit, and perform the method according to any one of the first aspect, the third aspect, and the fifth aspect. There are one or more processors.

A sixteenth aspect of this disclosure provides a second apparatus, including a processor and an interface circuit. The processor is configured to: communicate with another apparatus through the interface circuit, and perform the method according to any one of the second aspect, the fourth aspect, and the sixth aspect. There are one or more processors.

A seventeenth aspect of this disclosure provides a first apparatus, including a processor, configured to be connected to a memory, and configured to invoke a program stored in the memory, to perform the method according to any one of the first aspect, the third aspect, and the fifth aspect. The memory may be located inside or outside the first apparatus. There are one or more processors.

An eighteenth aspect of this disclosure provides a second apparatus, including a processor, configured to be connected to a memory, and configured to invoke a program stored in the memory, to perform the method according to any one of the second aspect, the fourth aspect, and the sixth aspect. The memory may be located inside or outside the second apparatus. There are one or more processors.

In an implementation, the first apparatus in the seventh aspect, the ninth aspect, the eleventh aspect, the thirteenth aspect, or the fifteenth aspect may be a chip (system).

In an implementation, the second apparatus in the eighth aspect, the tenth aspect, the twelfth aspect, the fourteenth aspect, or the sixteenth aspect may be a chip (system).

A nineteenth aspect of this disclosure provides a computer program product including instructions. When the computer program product runs on a computer, the computer is enabled to perform any one of the implementations of the first aspect to the sixth aspect.

A twentieth aspect of this disclosure provides a computer-readable storage medium, including computer instructions. When the instructions are run on a computer, the computer is enabled to perform any one of the implementations of the first aspect to the sixth aspect.

A twenty-first aspect of this disclosure provides a chip apparatus, including a processor, configured to invoke a computer program or computer instructions in a memory, to enable the processor to perform any one of the implementations of the first aspect to the sixth aspect.

Optionally, the processor is coupled to the memory through an interface.

A twenty-second aspect of this disclosure provides a communication system. The communication system includes the first apparatus according to the seventh aspect and the second apparatus according to the eighth aspect; the communication system includes the first apparatus according to the ninth aspect and the second apparatus according to the tenth aspect; or the communication system includes the first apparatus according to the eleventh aspect and the second apparatus according to the twelfth aspect.

It can be learned from the foregoing technical solutions that, the first apparatus receives first information from the second apparatus, where the first information indicates whether the first apparatus sends each local model parameter of a first model of the first apparatus; and the first apparatus determines a part of to-be-sent local model parameters of the first model based on the first information. The part of the local model parameters is obtained by training the first model. The first apparatus sends the part of the local model parameters of the first model to the second apparatus. It can be learned that the first apparatus may determine the part of the local model parameters of the first model based on the first information, and send the part of the local model parameters of the first model. The first apparatus does not need to send all the local model parameters of the first model. Therefore, signaling overheads of reporting a local model parameter of the first model by the first apparatus are reduced.

### BRIEF DESCRIPTION OF DRAWINGS

FIG. 1 is a diagram of a communication system according to an embodiment of this disclosure;

FIG. 2 is a diagram of a first embodiment of a communication method according to an embodiment of this disclosure;

FIG. 3 is a diagram of a format of N global model parameters and N pieces of first indication information in same signaling according to an embodiment of this disclosure;

FIG. 4 is a diagram of another format of N global model parameters and N pieces of first indication information in same signaling according to an embodiment of this disclosure;

FIG. 5 is a diagram of a format of a global model parameter of P layers of neurons of a first model and P pieces of second indication information in same signaling according to an embodiment of this disclosure;

FIG. 6 is a diagram of another format of a global model parameter of P layers of neurons of a first model and P pieces of second indication information in same signaling according to an embodiment of this disclosure;

FIG. 7 is a diagram of a second embodiment of a communication method according to an embodiment of this disclosure;

FIG. 8 is a diagram of a third embodiment of a communication method according to an embodiment of this disclosure;

FIG. 9 is a diagram of a structure of a first apparatus according to an embodiment of this disclosure;

FIG. 10 is a diagram of a structure of a second apparatus according to an embodiment of this disclosure;

FIG. 11 is a diagram of a structure of a terminal device according to an embodiment of this disclosure; and

FIG. 12 is a diagram of a structure of a network device according to an embodiment of this disclosure.

### DESCRIPTION OF EMBODIMENTS

Embodiments of this disclosure provide a communication method and a related apparatus, to reduce signaling overheads of sending a local model parameter of a first model by a first apparatus.

The following clearly describes the technical solutions in embodiments of this disclosure with reference to the accompanying drawings in embodiments of this disclosure. The described embodiments are merely a part of but not all of embodiments of this disclosure. All other embodiments obtained by persons skilled in the art based on embodiments of this disclosure without creative efforts shall fall within the protection scope of this disclosure.

Reference to “an embodiment”, “some embodiments”, or the like described in this disclosure indicates that one or more embodiments of this disclosure include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

In descriptions of this disclosure, unless otherwise specified, “/” means “or”. For example, A/B may indicate A or B. A term “and/or” in this specification describes only an association relationship between associated objects and indicates that there may be three relationships. For example, A and/or B may indicate the following three cases: Only A exists, both A and B exist, and only B exists. In addition, “at least one” means one or more, and “a plurality of” means two or more. “At least one of the following items (pieces)” or a similar expression thereof indicates any combination of these items, including a single item (piece) or any combination of a plurality of items (pieces). For example, at least one item (piece) of a, b, or c may indicate a, b, c, a and b, a and c, b and c, or a, b, and c, where a, b, and c may be singular or plural.

The technical solutions of this disclosure may be applied to a cellular communication system related to the 3rd generation partnership project (3GPP), for example, a 4th generation (4G) communication system, a 5th generation (5G) communication system, or a communication system after the 5th generation communication system, for example, a sixth generation communication system. For example, the 4th generation communication system may include a long term evolution (LTE) communication system. The 5th generation communication system may include a new radio (NR) communication system. The technical solutions of this disclosure may also be applied to a wireless fidelity (Wi-Fi) system, a communication system that supports convergence of a plurality of wireless technologies, a device-to-device (D2D) system, a vehicle-to-everything (V2X) communication system, and the like.

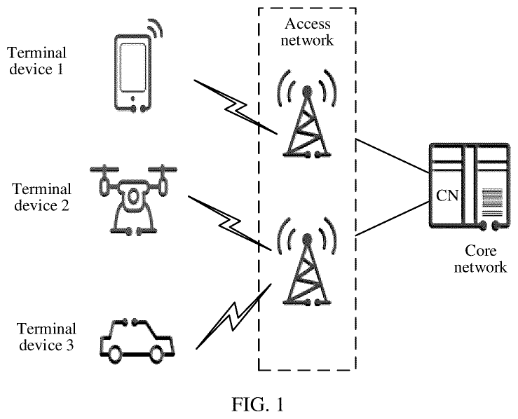

With reference to FIG. 1, the following describes a possible communication system to which this disclosure is applicable.

FIG. 1 is a diagram of a communication system according to an embodiment of this disclosure. Refer to FIG. 1. The communication system includes a terminal device, an access network, and a core network. The access network includes an access network device, and the terminal device may perform communicative transmission with the access network device. The core network includes a core network device. The terminal device may implement communicative transmission with the core network device via the access network device.

The following describes the terminal device, the access network device, and the core network device in this disclosure.

In this disclosure, the terminal device is a device having a wireless transceiver function, and further has a computing capability. The terminal device may perform machine learning training by using local data, and send, to a network device, related information about a model obtained by the terminal device through training.

The terminal device may be user equipment (UE), an access terminal, a subscriber unit, a subscriber station, a mobile station, a remote station, a remote terminal, a mobile device, a user terminal, a wireless communication device, a customer premises equipment (CPE), a user agent, or a user apparatus. Alternatively, the terminal device may be a satellite phone, a cellular phone, a smartphone, a wireless data card, a wireless modem, a machine type communication device, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, a vehicle, a communication device carried on a high-altitude aircraft, a wearable device, an unmanned aerial vehicle, a robot, a terminal in D2D, a terminal in V2X, a virtual reality (VR) terminal device, an augmented reality (AR) terminal device, a wireless terminal in industrial control, a wireless terminal in self driving, a wireless terminal in telemedicine, a wireless terminal in a smart grid, a wireless terminal in transportation safety, a wireless terminal in a smart city, a wireless terminal in a smart home, a terminal device in a future communication network, or the like. This is not limited in this disclosure.

In this disclosure, the access network device has a wireless transceiver function, and further has a computing capability. The access network device is configured to communicate with the terminal device. In other words, the access network device may be a device that connects the terminal device to a wireless network. The access network device may be a network node having a computing capability. For example, the access network device may be an artificial intelligence (AI) node, a computing node, or an access network node having an AI capability in the access network. The access network device may aggregate models trained by a plurality of terminal devices, and then send an aggregated model to the terminal devices. In this way, joint learning between the plurality of terminal devices is implemented.

The access network device may be a node in a radio access network. The access network device may be referred to as a base station, or may be referred to as a radio access network (RAN) node or a RAN device. The access network device may be an evolved NodeB (eNB or eNodeB) in LTE, a next generation NodeB (gNB) in a 5G network, a base station in a future evolved public land mobile network (PLMN), a broadband network gateway (BNG), an aggregation switch, a non-3rd generation partnership project (3GPP) access device, or the like. Optionally, the access network device in embodiments of this disclosure may include base stations in various forms, for example, a macro base station, a micro base station (also referred to as a small cell), a relay station, an access point, a device that implements a base station function in a communication system evolved after 5G, an access point (AP), a transmission reception point (TRP), a transmit point (TP) in a Wi-Fi system, a mobile switching center, a device that implements a base station function in D2D communication, V2X device communication, or machine-to-machine (M2M) communication. The access network device may further include a central unit (CU) and a distributed unit (DU) in a cloud access network (C-RAN) system, and an access network device in a non-terrestrial network (NTN) communication system, that is, may be deployed on a high-altitude platform or a satellite. This is not limited in this disclosure.

In this disclosure, the core network device is a control plane network function provided by a network, and is responsible for access control, registration management, service management, mobility management, and the like for accessing the network by the terminal device. In embodiments of this disclosure, the core network device may be an access and mobility management function (AMF) in a 5G communication system, a core network device in a future network, or the like. The core network device may be a network node having a computing capability. For example, the core network device may be an AI node, a computing node, or a core network node having an AI capability in the core network. A specific type of the core network device is not limited in this disclosure. In different communication systems, names of the core network device may be different.

A communication system to which the technical solutions of this disclosure are applicable includes a first apparatus and a second apparatus. The following describes some possible forms of the first apparatus and the second apparatus. This disclosure is still applicable to another form, and the following example does not constitute a limitation on this disclosure.

1. The first apparatus is a terminal device or a chip in a terminal device, and the second apparatus is a network device or a chip in a network device.

2. The first apparatus is an access network device or a chip in an access network device, and the second apparatus is a core network device or a chip in a core network device.

3. The first apparatus is a terminal device or a chip in a terminal device, and the second apparatus is a core network device or a chip in a core network device.

4. The first apparatus is a first access network device or a chip in a first access network device, and the second apparatus is a second access network device or a chip in a second access network device.

5. The first apparatus is a first core network device or a chip in a first core network device, and the second apparatus is a second core network device or a chip in a second core network device.

6. The first apparatus is a terminal device or a chip in a terminal device, and the second apparatus is a server or a chip in a server.

For the 5G network, research has begun from R16 on supporting an AI function in the 5G network via an NWDAF network element. The NWDAF network element is mainly configured to: collect and analyze data at an application layer, and externally provide a service and an interface for invoking. In R18, there is a research topic on function extension of the NWDAF network element, to provide support for an AI service externally, perform model transmission in a network, and the like.

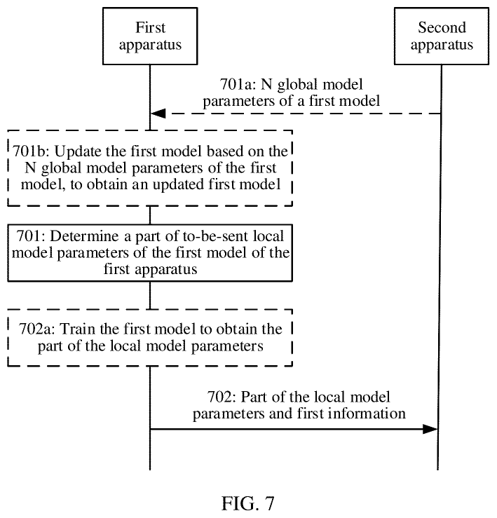

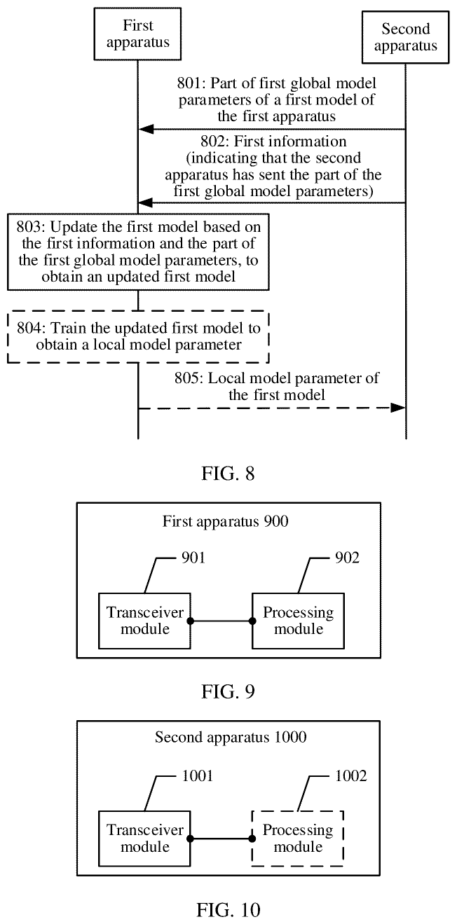

A combination of AI and the network is an important direction of future research. Transmission of a large quantity of related parameters of a model needs to be performed over the network. As a scale of the model becomes larger, there are more related parameters of the model. In this case, in a wireless network, transmission of the related parameters of the model causes huge signaling overheads. Therefore, how to reduce signaling overheads of transmission of the related parameters of the model between devices is a problem worth considering. This disclosure provides a corresponding technical solution, to reduce signaling overheads of sending a model parameter by the first apparatus or the second apparatus. For details, refer to following related descriptions of the embodiments shown in FIG. 2, FIG. 7, and FIG. 8.

The technical solutions provided in this disclosure are applicable to a distributed learning communication system. Distributed learning is a learning method that implements joint learning. Specifically, a plurality of first apparatuses each obtain a local model through training by using local data. The second apparatus aggregates a plurality of local models to obtain a global model. Therefore, joint learning is implemented on a premise that privacy of user data of the plurality of first apparatuses is protected. Optionally, the distributed learning includes federated learning, split learning, or transfer learning.

For ease of understanding the technical solutions of this disclosure, the following describes a neural network.

The neural network may include a neuron. The neuron may be an operation unit that use xₛ and an intercept 1 as an input. An output of the operation unit may be:

$${h}_{W , b} ( x ) = f ( {W}^{T} x ) = f ( {\sum }_{s = 1}^{n} {W}_{s} {x}_{s} + b ) \qquad ( 1 )$$

s=1, 2, . . . , and n, n is a natural number greater than 1, and Wₛ is a weight of xₛ. It should be noted that, optionally, the weight of xₛ may alternatively be calculated by adding a weight gradient to a weight used by the neuron last time. b is an offset of the neuron. f is an activation function of the neuron, and is used to introduce a non-linear characteristic into the neural network, to convert an input signal in the neuron into an output signal. In other words, an input parameter is input into one neuron, and the neuron may output a corresponding output parameter. The neural network is a network formed by connecting a plurality of single neurons, in other words, an output of one neuron may be an input of another neuron.

The neural network may have a plurality of layers of neurons. The following uses a deep neural network (DNN) as an example for description. The deep neural network is a neural network with many hidden layers. A multi-layer neural network and the deep neural network are essentially the same. The DNN is divided based on locations of different layers, and a neural network in the DNN may be divided into three types: an input layer, a hidden layer, and an output layer. Generally, a 1^{st} layer is the input layer, a last layer is the output layer, and a middle layer is the hidden layer. Layers are fully connected. In other words, any neuron at an i^{th} layer is necessarily connected to any neuron at an (i+1)^{th} layer. In the deep neural network, more hidden layers make the network more capable of describing a complex case in the real world. Theoretically, a model with more model parameters has higher complexity and a larger “capacity”. It indicates that the model can complete a more complex learning task.

The technical solutions of this disclosure are described below with reference to specific embodiments.

FIG. 2 is a diagram of a first embodiment of a communication method according to an embodiment of this disclosure. Refer to FIG. 2. The method includes the following steps.

201: A second apparatus sends first information to a first apparatus. The first information indicates whether the first apparatus sends each local model parameter of a first model of the first apparatus. Correspondingly, the first apparatus receives the first information from the second apparatus.

The local model parameter is a model parameter obtained by the first apparatus by training the first model based on local data of the first apparatus. In other words, the model parameter obtained by training the first model by using the local data of the first apparatus as an input parameter of the first model may be referred to as the local model parameter.

Optionally, the local model parameter is a local weight parameter or another related parameter of the first model. This is not specifically limited in this disclosure. For example, the local model parameter is an output parameter of the first model. Optionally, the local weight parameter includes a local weight or a local weight gradient of the first model.

Each local model parameter of the first model includes all or a part of local model parameters of the first model. The following mainly describes the technical solutions of this disclosure by using an example in which each local model parameter of the first model includes all the local model parameters of the first model.

The following describes some possible implementations of the first information.

Implementation 1: All the local model parameters of the first model include N local model parameters, and N is an integer greater than or equal to 2. The first information includes N pieces of first indication information, and the N pieces of first indication information are in one-to-one correspondence with the N local model parameters. First indication information corresponding to each of the N local model parameters indicates whether the first apparatus sends the local model parameter.

Optionally, each of the N pieces of first indication information includes one bit. Therefore, the N pieces of first indication information include N bits. For example, if a value of one of the N pieces of first indication information is 1, the first indication information indicates the first apparatus to send a local model parameter corresponding to the first indication information. If a value of one piece of first indication information is 0, the first indication information indicates the first apparatus not to send a local model parameter corresponding to the first indication information. Alternatively, for example, if a value of one of the N pieces of first indication information is 0, the first indication information indicates the first apparatus to send a local model parameter corresponding to the first indication information. If a value of one piece of first indication information is 1, the first indication information indicates the first apparatus not to send a local model parameter corresponding to the first indication information.

Optionally, the N bits form a first bit sequence. For example, the N local model parameters include 10 local model parameters: a local model parameter 1 to a local model parameter 10. The first bit sequence is 1000111001. A 1^{st} bit corresponds to the local model parameter 1, a 2^{nd} bit corresponds to the local model parameter 2, the rest may be deduced by analogy, and a 10^{th} bit corresponds to the local model parameter 10. It can be learned that the second apparatus indicates, by using the first bit sequence, the first apparatus to send the local model parameter 1, the local model parameter 5 to the local model parameter 7, and the local model parameter 10. Other local model parameters may not be sent.

Optionally, the N bits are N elements in a first matrix. The N elements are in one-to-one correspondence with the N local model parameters. One of the N elements indicates whether the first apparatus sends a local model parameter corresponding to the element. For example, the first model is a neural network model, and a dimension of the first matrix is determined based on a quantity of layers included in the neural network model and a quantity of local model parameters included in each layer of neurons. The neural network model includes five layers of neurons, and each layer of neurons includes four local model parameters. Therefore, the dimension of the first matrix may be 5*4.

Optionally, the embodiment shown in FIG. 2 further includes step 201a. Step 201a may be performed before step 203a.

201a: The second apparatus sends N global model parameters of the first model to the first apparatus. Correspondingly, the first apparatus receives the N global model parameters of the first model from the second apparatus.

Specifically, the second apparatus aggregates local model parameters of a plurality of first apparatuses to obtain the N global model parameters of the first model. Then, the second apparatus sends the N global model parameters of the first model to the first apparatus.

The global model parameter is obtained by the second apparatus by aggregating the local model parameters of the plurality of first apparatuses. In other words, the second apparatus obtains the global model parameter of the first model based on the local model parameters of the plurality of first apparatuses with reference to a corresponding operation. For example, the first model is a neural network model, and the plurality of first apparatuses separately report a local model parameter of a neuron 1 in the neural network model. The second apparatus averages local model parameters that are of the neuron 1 and that are respectively reported by the plurality of first apparatuses, to obtain a global model parameter of the neuron 1.

The N global model parameters of the first model are in one-to-one correspondence with the N local model parameters of the first model. For example, the first model is a neural network model. The N global model parameters include eight global model parameters: a global model parameter 1 to a global model parameter 8. The N local model parameters include eight local model parameters: a local model parameter 1 to a local model parameter 8. The global model parameter 1 is a global model parameter of a neuron 1. The local model parameter 1 is a local model parameter of the neuron 1. Therefore, the global model parameter 1 corresponds to the local model parameter 1. By analogy, the global model parameter 8 is a global model parameter of a neuron 8, and the local model parameter 8 is a local model parameter of the neuron 8. Therefore, the global model parameter 8 corresponds to the local model parameter 8.

The following describes two possible sending manners of the N global model parameters of the first model and the N pieces of first indication information.

1. The N global model parameters of the first model and the N pieces of first indication information are carried in same signaling.

Specifically, the N pieces of first indication information are delivered together with the N global model parameters of the first model. The following describes two possible formats of the N global model parameters of the first model and the N pieces of first indication information in the same signaling.

A. The N global model parameters and the N pieces of first indication information are arranged at intervals, and first indication information corresponding to each global model parameter is adjacently arranged after the global model parameter.

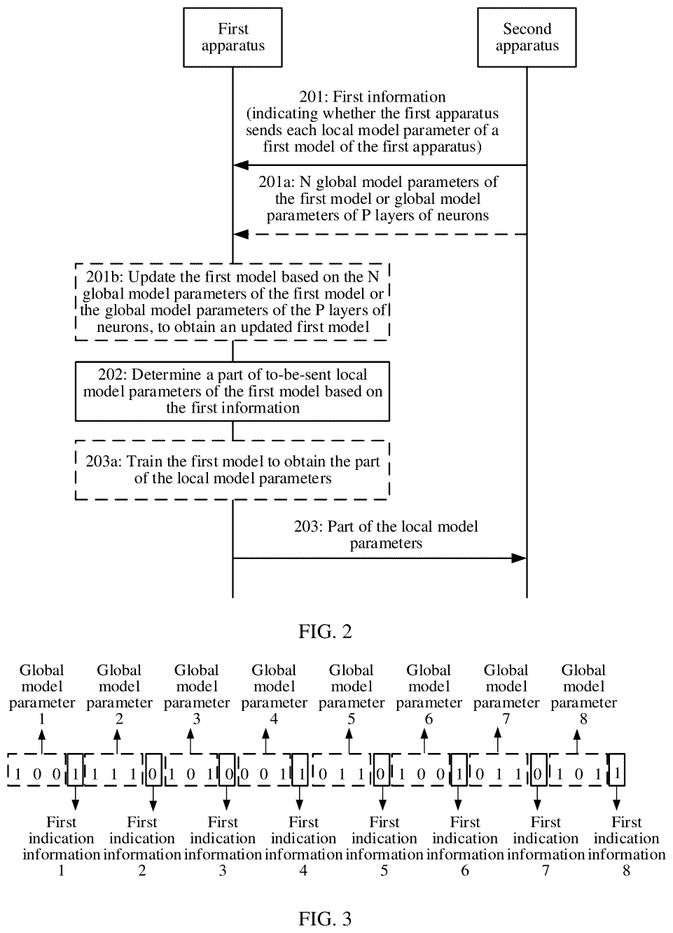

For example, each of the N pieces of first indication information includes one bit. As shown in FIG. 3, the N global model parameters include eight global model parameters: a global model parameter 1 to a global model parameter 8. A value of the global model parameter 1 is 100, the global model parameter 1 corresponds to first indication information 1, and a value of the first indication information 1 is 1. In other words, the global model parameter 1 is immediately followed by the first indication information 1. The first indication information 1 indicates whether the first apparatus sends a local model parameter 1 corresponding to the first indication information 1. By analogy, a value of the global model parameter 8 is 101, and the global model parameter 8 corresponds to first indication information 8. The first indication information 8 indicates whether the first apparatus sends a local model parameter 8 corresponding to the first indication information 8.

B. The N global model parameters are arranged before the N pieces of first indication information. In other words, the N global model parameters are first sent, and the N pieces of first indication information are then sent. It can be understood that a spacing between each global model parameter and first indication information corresponding to the global model parameter is equal.

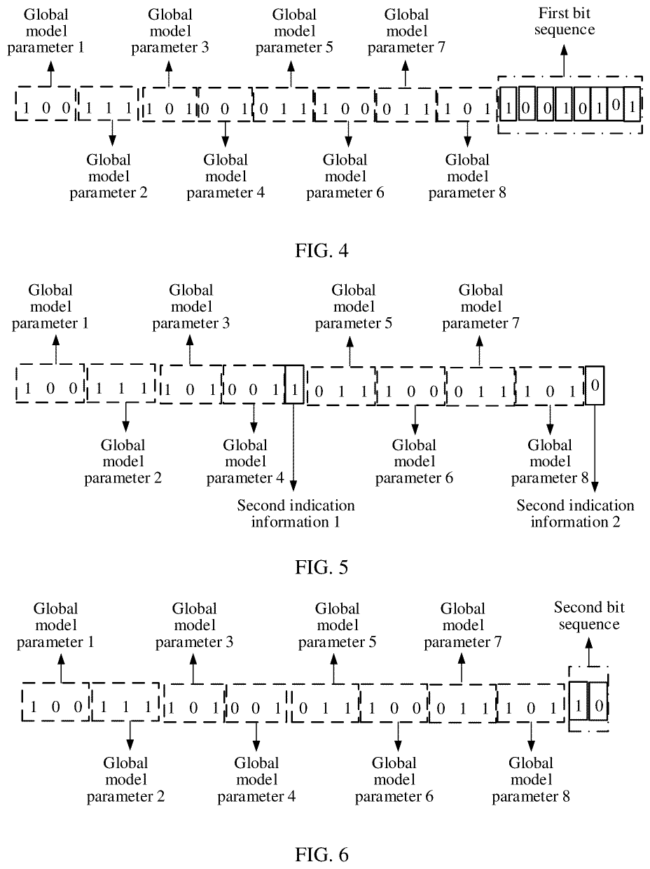

For example, each of the N pieces of first indication information includes one bit. As shown in FIG. 4, the N global model parameters include eight global model parameters: a global model parameter 1 to a global model parameter 8. The eight global model parameters are arranged at intervals. The N pieces of first indication information include eight bits, and the eight bits form a first bit sequence. The first bit sequence is arranged after the eight global model parameters. The global model parameter 1 corresponds to a 1^{st} bit in the first bit sequence, and the 1^{st} bit indicates whether the first apparatus sends a local model parameter 1 corresponding to the bit. By analogy, the global model parameter 8 corresponds to an 8^{th} bit in the first bit sequence, and the 8^{th} bit indicates whether the first apparatus sends a local model parameter 8 corresponding to the bit.

Optionally, the N global model parameters of the first model and the N pieces of first indication information may be carried in same radio resource control (RRC) signaling.

2. The N global model parameters of the first model and the N pieces of first indication information are carried in different signaling.

In this implementation, the second apparatus separately sends the N global model parameters and the N pieces of first indication information.

For example, each of the N pieces of first indication information includes one bit, the N pieces of first indication information include the N bits, and the N bits form the first bit sequence. The second apparatus separately sends the N global model parameters and the first bit sequence.

Optionally, the N global model parameters of the first model and the N pieces of first indication information may be carried in different RRC signaling.

Implementation 2: All the local model parameters of the first model include local model parameters of P layers of neurons, and P is an integer greater than or equal to 1. The first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter.

Optionally, each of the P pieces of second indication information includes one bit. Therefore, the P pieces of second indication information include P bits. For example, if a value of one of the P pieces of second indication information is 1, the second indication information indicates the first apparatus to send a local model parameter that is of a layer of neurons and that corresponds to the second indication information. If a value of one piece of second indication information is 0, the second indication information indicates the first apparatus not to send a local model parameter that is of a layer of neurons and that corresponds to the second indication information. Alternatively, if a value of one of the P pieces of second indication information is 0, the second indication information indicates the first apparatus to send a local model parameter that is of a layer of neurons and that corresponds to the second indication information. If a value of one piece of second indication information is 1, the second indication information indicates the first apparatus not to send a local model parameter that is of a layer of neurons and that corresponds to the second indication information.

Optionally, the P bits form a second bit sequence. For example, the local model parameters of the P layers of neurons include local model parameters of five layers of neurons. The second bit sequence is 10001. A 1^{st} bit corresponds to a local model parameter of a 1^{st} layer of neurons, a 2^{nd} bit corresponds to a local model parameter of a 2^{nd} layer of neurons, the rest may be deduced by analogy, and a 5^{th} bit corresponds to a local model parameter of a 5^{th} layer of neurons. It can be learned that the second apparatus indicates, by using the second bit sequence, the first apparatus to send the local model parameter of the 1^{st} layer of neurons and the local model parameter of the 5^{th} layer of neurons, without the need to send local model parameters of other layers of neurons.

Optionally, the P bits may be P elements in a second matrix, and the P elements are in one-to-one correspondence with the local model parameters of the P layers of neurons. One of the P elements indicates whether the first apparatus sends a local model parameter that is of a layer of neurons and that corresponds to the element. For example, the first model is a neural network model, and a dimension of the second matrix is determined based on a quantity of layers included in the neural network model. For example, the neural network model includes five layers of neurons. Therefore, the dimension of the second matrix is 5*1.

Optionally, the embodiment shown in FIG. 2 further includes step 201a. Step 201a may be performed before step 203a.

201a: The second apparatus sends global model parameters of the P layers of neurons of the first model to the first apparatus. Correspondingly, the first apparatus receives the global model parameters of the P layers of neurons of the first model from the second apparatus.

The global model parameters of the P layers of neurons of the first model are in one-to-one correspondence with the local model parameters of the P layers of neurons of the first model.

For example, the first model includes two layers of neurons, and each layer of neurons includes four global model parameters. For example, global model parameters of a 1^{st} layer of neurons include a global model parameter 1 to a global model parameter 4. Global model parameters of a 2^{nd} layer of neurons include a global model parameter 5 to a global model parameter 8. Local model parameters of the 1^{st} layer of neurons include a local model parameter 1 to a local model parameter 4. Local model parameters of the 2^{nd} layer of neurons include a local model parameter 5 to a local model parameter 8. The global model parameters of the 1^{st} layer of neurons correspond to the local model parameters of the 1st layer of neurons. The global model parameters of the 2^{nd} layer of neurons correspond to the local model parameters of the 2^{nd} layer of neurons.

The following describes two possible sending manners of the global model parameters of the P layers of neurons of the first model and the P pieces of second indication information.

1. The global model parameters of the P layers of neurons of the first model and the P pieces of second indication information are carried in same signaling.

Specifically, the P pieces of second indication information are delivered together with the global model parameters of the P layers of neurons of the first model. The following describes two possible formats of the global model parameters of the P layers of neurons of the first model and the P pieces of second indication information in the same signaling.

A. The global model parameters of the P layers of neurons and the P pieces of second indication information are arranged at intervals, and second indication information corresponding to a global model parameter of each layer of neurons is adjacently arranged after the global model parameter of the each layer of neurons.

For example, each of the P pieces of second indication information includes one bit. As shown in FIG. 5, the global model parameters of the P layers of neurons include global model parameters of two layers of neurons. Global model parameters of a 1^{st} layer of neurons include a global model parameter 1 to a global model parameter 4. Global model parameters of a 2^{nd} layer of neurons include a global model parameter 5 to a global model parameter 8. The global model parameters of the 1^{st} layer of neurons correspond to second indication information 1. A value of the second indication information 1 is 1. In other words, the global model parameters of the 1^{st} layer of neurons are immediately followed by the second indication information 1. The global model parameters of the 2^{nd} layer of neurons correspond to second indication information 2. A value of the second indication information 2 is 0. In other words, the global model parameters of the 2^{nd} layer of neurons are immediately followed by the second indication information 2.

B. The global model parameters of the P layers of neurons are arranged before the P pieces of second indication information. Further, optionally, a spacing between a global model parameter of each layer of neurons and second indication information corresponding to the global model parameter of the each layer of neurons is equal.

For example, each of the P pieces of second indication information includes one bit. As shown in FIG. 6, the global model parameters of the P layers of neurons include global model parameters of two layers of neurons. Global model parameters of a 1^{st} layer of neurons include a global model parameter 1 to a global model parameter 4. Global model parameters of a 2^{nd} layer of neurons include a global model parameter 5 to a global model parameter 8. The global model parameters of the two layers of neurons are arranged at intervals. The P pieces of second indication information include two bits, and the two bits form a second bit sequence. The second bit sequence is arranged after the global model parameters of the two layers of neurons. The global model parameters of the 1^{st} layer of neurons correspond to a 1^{st} bit in the second bit sequence, and the 1^{st} bit indicates whether the first apparatus sends local model parameters that are of the 1^{st} layer of neurons and that correspond to the bit. A 2^{nd} bit indicates whether the first apparatus sends local model parameters that are of the 2^{nd} layer of neurons and that correspond to the bit.

Optionally, the global model parameters of the P layers of neurons and the P pieces of second indication information may be carried in same RRC signaling.

2. The global model parameters of the P layers of neurons of the first model and the P pieces of second indication information are carried in different signaling.

In this implementation, the second apparatus separately sends the global model parameters of the P layers of neurons and the P pieces of second indication information.

For example, each of the P pieces of second indication information includes one bit, and the P pieces of second indication information include P bits. The P bits form the second bit sequence. The second apparatus separately sends the global model parameters of the P layers of neurons and the second bit sequence.

Optionally, the global model parameters of the P layers of neurons and the P pieces of second indication information may be carried in different RRC signaling.

Implementation 3: All the local model parameters of the first model include local model parameters of P layers of neurons, and P is an integer greater than or equal to 1. The first information includes a first flag bit and a layer sequence number of at least one first target layer in the P layers of neurons. The first flag bit indicates the first apparatus not to send a local model parameter of a neuron of the at least one first target layer. Alternatively, the first information includes a second flag bit and a layer sequence number of at least one second target layer in the P layers of neurons. The second flag bit indicates the first apparatus to send a local model parameter of a neuron of the at least one second target layer.

For example, the P layers of neurons include 10 layers of neurons. A layer sequence number of a 1^{st} layer is 1, a layer sequence number of a 2^{nd} layer is 2, the rest may be deduced by analogy, and a layer sequence number of a 10^{th} layer is 10. The first information includes content shown in Table 1. The at least one first target layer includes the 3^{rd} layer and the 7^{th} layer. Therefore, the first information includes the layer sequence number of the 3^{rd} layer, the layer sequence number of the 7^{th} layer, and the first flag bit that are shown in Table 1. A value of the first flag bit being 0 indicates the first apparatus not to send a local model parameter of the 3^{rd} layer of neurons and a local model parameter of the 7^{th} layer of neurons.

TABLE 1

| Layer sequence number | First flag bit |
|---|---|
| 3 | 0 |
| 7 | |

It can be learned that in a scenario in which there are a small quantity of first target layers, the second apparatus may send the first information in this implementation. Therefore, signaling overheads produced when the second apparatus sends the first information are reduced.

For example, the P layers of neurons include five layers of neurons. A layer sequence number of a 1^{st} layer is 1, a layer sequence number of a 2^{nd} layer is 2, the rest may be deduced by analogy, and a layer sequence number of a 5^{th} layer is 5. The first information includes content shown in Table 2. The at least one second target layer includes the 1^{st} layer and the 3^{rd} layer. Therefore, the first information includes the layer sequence number of the 1^{st} layer, the layer sequence number of the 3^{rd} layer, and the second flag bit that are shown in Table 2. A value of the second flag bit being 1 indicates the first apparatus to send a local model parameter of the 1^{st} layer of neurons and a local model parameter of the 3^{rd} layer of neurons.

TABLE 2

| Layer sequence number | second flag bit |
|---|---|
| 1 | 1 |
| 3 | |

It can be learned that in a scenario in which there are a small quantity of second target layers, the second apparatus may send the first information in this implementation. Therefore, signaling overheads produced when the second apparatus sends the first information are reduced.

It should be noted that Implementation 2 and Implementation 3 each show an implementation in which the second apparatus indicates, by using the first information, whether the first apparatus sends a local model parameter of each of the P layers of neurons. In some embodiments, on this basis, for a to-be-sent local model parameter, the second apparatus may further indicate the first apparatus to send a specific to-be-sent local model parameter of a layer of neurons. This is not specifically limited in this disclosure. For example, the first information further includes third indication information, and the third indication information indicates whether the first apparatus sends each to-be-sent local model parameter of the layer of neurons.

Optionally, the second apparatus determines the first information based on at least one of the following: local model parameters reported by the plurality of first apparatuses, a global model parameter obtained by the second apparatus by aggregating the local model parameters reported by the plurality of first apparatuses, statuses of communication links in which the plurality of first apparatuses are respectively located, and operation capabilities of the plurality of first apparatuses.

For example, if the statuses of the communication links in which the plurality of first apparatuses are respectively located are poor or the operation capabilities of the plurality of first apparatuses are poor, the second apparatus may indicate, by using the first information, the first apparatus to report a small quantity of local model parameters of the first model.

For example, there is a small variation between a global model parameter obtained by the second apparatus by aggregating, in an (R+1)^{th} round, local model parameters reported by the plurality of first apparatuses, and a global model parameter obtained by aggregating, in an R^{th} round, local model parameters reported by the plurality of first apparatuses. In this case, the second apparatus may indicate, by using the first information, the first apparatus to report a local model parameter corresponding to a global model parameter with a relatively large variation. R is an integer greater than or equal to 1.

The first apparatus may accurately update the first model with reference to the global model parameter.

It should be noted that in this embodiment, first information determined by the second apparatus for different first apparatuses may be the same or may be different. This is not specifically limited in this disclosure.

202: The first apparatus determines a part of to-be-sent the local model parameters of the first model based on the first information.

The part of the local model parameters is obtained by training the first model.

For example, as shown in FIG. 3, the first apparatus may determine the part of the local model parameters based on the eight pieces of first indication information. Specifically, the part of the local model parameters includes the local model parameter 1, the local model parameter 4, the local model parameter 6, and the local model parameter 8.

For example, as shown in FIG. 5, the first apparatus determines the part of the local model parameters based on the two pieces of second indication information. Specifically, the part of the local model parameters includes the local model parameters of the 1^{st} layer of neurons, which are specifically the local model parameter 1 to the local model parameter 4.

203: The first apparatus sends the part of the local model parameters to the second apparatus. Correspondingly, the second apparatus receives the part of the local model parameters from the first apparatus.

Optionally, the embodiment shown in FIG. 2 further includes step 203a. Step 203a may be performed before step 203.

203a: The first apparatus trains the first model to obtain the part of the local model parameters of the first model.

In this implementation, after the first apparatus determines the part of to-be-sent the local model parameters of the first model based on the first information, the first apparatus may calculate only the part of the local model parameters of the first model, and the first apparatus may not calculate a local model parameter that is of the first model and that does not need to be sent. Therefore, a local calculation amount of the first apparatus is reduced, and an energy consumption loss of the first apparatus is reduced.

Optionally, based on step 201a, the embodiment shown in FIG. 2 further includes step 201b. Step 201b may be performed before step 203a.

201b: The first apparatus updates the first model based on the N global model parameters of the first model or the global model parameters of the P layers of neurons, to obtain an updated first model.

Optionally, based on step 201b, step 203a specifically includes: The first apparatus trains the updated first model to obtain the part of the local model parameters of the first model.

It should be noted that, optionally, effective time of the first information in step 201 may be a time interval between a moment at which the second apparatus sends the first information and a moment at which the second apparatus updates the first information.

Optionally, if the second apparatus expects the first apparatus to send all the local model parameters of the first model, the second apparatus may send updated first information to the first apparatus. Optionally, the updated first information may be an all-zero bit sequence, and the all-zero bit sequence indicates the first apparatus to send all the local model parameters of the first model. Alternatively, the first information is stop signaling, and the stop signaling indicates the first apparatus to send all the local model parameters of the first model.

For example, when a first condition is met, the second apparatus sends the updated first information to the first apparatus. The updated first information indicates the first apparatus to send all the local model parameters of the first model. The first condition includes at least one of the following: a computing resource of the first apparatus is abundant; a communication resource between the first apparatus and the second apparatus is abundant; or a service of the first apparatus is idle.

It should be noted that there is no fixed sequence of performing step 201a, step 201b, step 203a, and step 202. Step 201a, step 201b, and step 203a are performed before step 202; step 202 is performed before step 201a, step 201b, and step 203a; or step 201a, step 201b, step 203a, and step 202 are performed based on a case. This is not specifically limited in this disclosure.

It can be learned that the second apparatus determines the first information with reference to the foregoing shown factors. Then, the first apparatus sends the part of the local model parameters of the first model to the second apparatus. The second apparatus may accurately determine a global model parameter of the first model with reference to the part of model parameters, and send the global model parameter of the first model to the first apparatus. The global model parameter of the first model is used by the first apparatus to update the first model. In this way, overheads of sending a local model parameter of the first model by the first apparatus are reduced while accuracy of the first model is ensured.

In this embodiment of this disclosure, the first apparatus receives the first information from the second apparatus, where the first information indicates whether the first apparatus sends each local model parameter of the first model of the first apparatus; and the first apparatus determines the part of to-be-sent the local model parameters of the first model based on the first information. The part of the local model parameters is obtained by training the first model. The first apparatus sends the part of the local model parameters of the first model to the second apparatus. It can be learned that the first apparatus may determine the part of the local model parameters of the first model based on the first information, and send the part of the local model parameters of the first model. The first apparatus does not need to send all the local model parameters of the first model. Therefore, signaling overheads of sending the local model parameter of the first model by the first apparatus are reduced. In other words, a data volume of local model parameter transmission between apparatuses is greatly reduced, communication efficiency is improved, and energy consumed during the local model parameter transmission between the apparatuses is reduced, thereby achieving an energy saving effect.

It should be noted that in the embodiment shown in FIG. 2, step 201a and step 201b show a solution in which the second apparatus sends the N global model parameters of the first model or the global model parameters of the P layers of neurons to the first apparatus, and the first apparatus updates the first model based on the N global model parameters of the first model or the global model parameters of the P layers of neurons. In some embodiments, the second apparatus may send a part of the global model parameters of the first model to the first apparatus, and the first apparatus updates the first model based on the part of the global model parameters. A specific implementation process is similar to a process of step 801 to step 803 in the following embodiment shown in FIG. 8. For details, refer to related descriptions of step 801 to step 803 in the following embodiment shown in FIG. 8.

FIG. 7 is a diagram of a second embodiment of a communication method according to an embodiment of this disclosure. Refer to FIG. 7. The method includes the following steps.

701: A first apparatus determines a part of to-be-sent local model parameters of a first model of the first apparatus.

The part of the local model parameters of the first model is obtained by training the first model. For a meaning of the local model parameter, refer to the foregoing related descriptions.

Optionally, the part of the local model parameters includes a local weight parameter of the first model or another model-related parameter. This is not specifically limited in this disclosure. For example, the part of the local model parameters includes an output parameter of the first model. Optionally, the local weight parameter of the first model includes a local weight or a local weight gradient of the first model.

The following describes a possible implementation in which the first apparatus determines the part of to-be-sent the local model parameters of the first model of the first apparatus. This disclosure is also applicable to another implementation. This is not specifically limited in this disclosure.

Optionally, step 701 specifically includes: The first apparatus determines the part of to-be-sent the local model parameters of the first model of the first apparatus based on at least one of the following: a local model parameter obtained by the first apparatus by performing an R^{th} round of training on the first model, a status of a communication link on which the first apparatus is located, and an operation capability of the first apparatus. The part of the local model parameters is obtained by the first apparatus by performing an (R+1)^{th} round of training on the first model, and R is an integer greater than or equal to 1.

For example, when the status of the communication link on which the first apparatus is located is poor, the first apparatus may determine fewer to-be-sent local model parameters of the first model.

For example, when the operation capability of the first apparatus is poor, the first apparatus may determine a small quantity of to-be-sent local model parameters of the first model.

For example, the first apparatus may determine a local model parameter that is in all the local model parameters obtained by the first apparatus by performing the (R+1)^{th} round of training on the first model and whose variation is large in comparison with all local model parameters obtained by the first apparatus by performing the R^{th} round of training on the first model. The first apparatus may determine that the part of the local model parameters includes the local model parameter with the large variation.

702: The first apparatus sends the part of the local model parameters of the first model and first information to a second apparatus. Correspondingly, the second apparatus receives the part of the local model parameters of the first model and the first information from the first apparatus.

Optionally, the part of the local model parameters of the first model and the first information may be simultaneously sent, or may be separately sent. This is not specifically limited in this disclosure. In other words, the part of the local model parameters of the first model and the first information may be carried in same signaling, or may be carried in different signaling.

Specifically, the first apparatus determines the part of the local model parameters of the first model based on the first information, and determines a global model parameter of the first model based on the part of the local model parameters.

The following describes three possible implementations of the first information. This disclosure is also applicable to another implementation. This is not specifically limited in this disclosure.

Implementation 1: All the local model parameters of the first model include N local model parameters, and N is an integer greater than or equal to 2. The first information includes N pieces of first indication information, and the N pieces of first indication information are in one-to-one correspondence with the N local model parameters. First indication information corresponding to each of the N local model parameters indicates whether the first apparatus sends the local model parameter.

Optionally, each of the N pieces of first indication information includes one bit. Therefore, the N pieces of first indication information include N bits. For example, if a value of one of the N pieces of first indication information is 1, the first indication information indicates that the first apparatus has sent a local model parameter corresponding to the first indication information. If a value of the first indication information is 0, the first indication information indicates that the first apparatus has not sent a local model parameter corresponding to the first indication information. Alternatively, if a value of one of the N pieces of first indication information is 0, the first indication information indicates that the first apparatus has sent a local model parameter corresponding to the first indication information. If a value of the first indication information is 1, the first indication information indicates that the first apparatus has not sent a local model parameter corresponding to the first indication information.

For example, the N local model parameters include 10 local model parameters: a local model parameter 1 to a local model parameter 10. The N bits form a first bit sequence. The first bit sequence is 1000100111. A 1^{st} bit corresponds to the local model parameter 1, a 2^{nd} bit corresponds to the local model parameter 2, the rest may be deduced by analogy, and a 10^{th} bit corresponds to the local model parameter 10. If a value of a bit in the first bit sequence is 1, the first apparatus is indicated to send a local model parameter corresponding to the bit. If a value of a bit in the first bit sequence is 0, the first apparatus is indicated not to send a local model parameter corresponding to the bit. It can be learned that the second apparatus may determine, based on the first bit sequence, that the part of the model parameters includes the local model parameter 1, the local model parameter 5, the local model parameter 8, the local model parameter 9, and the local model parameter 10.

Optionally, the N bits may be N elements in a first matrix. The N elements are in one-to-one correspondence with the N local model parameters. One of the N elements indicates whether the first apparatus sends a local model parameter corresponding to the element. For example, the first model is a neural network model, and a dimension of the first matrix is determined based on a quantity of layers included in the neural network model and a quantity of local model parameters included in each layer of neurons. For example, the neural network model includes five layers of neurons, and each layer of neurons includes four local model parameters. Therefore, the dimension of the first matrix may be 5*4.

Implementation 2: All the local model parameters of the first model include local model parameters of P layers of neurons, and P is an integer greater than or equal to 1. The first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter of the layer of neurons.

Optionally, each of the P pieces of second indication information includes one bit. Therefore, the P pieces of second indication information include P bits. For example, if a value of one of the P pieces of second indication information is 1, the second indication information indicates that the first apparatus has sent a local model parameter that is of a layer of neurons and that corresponds to the second indication information. If a value of the second indication information is 0, the second indication information indicates that the first apparatus has not sent a local model parameter that is of a layer of neurons and that corresponds to the second indication information. Alternatively, if a value of one of the P pieces of second indication information is 0, the second indication information indicates that the first apparatus has sent a local model parameter that is of a layer of neurons and that corresponds to the second indication information. If a value of one piece of second indication information is 1, the second indication information indicates that the first apparatus has not sent a local model parameter that is of a layer of neurons and that corresponds to the second indication information.

For example, the local model parameters of the P layers of neurons include local model parameters of five layers of neurons. The P bits form a second bit sequence. The second bit sequence is 10010. A 1^{st} bit corresponds to a local model parameter of a 1^{st} layer of neurons, a 2^{nd} bit corresponds to a local model parameter of a 2^{nd} layer of neurons, the rest may be deduced by analogy, and a 5^{th} bit corresponds to a local model parameter of a 5^{th} layer of neurons. If a value of a bit in the second bit sequence is 1, the first apparatus is indicated to send a local model parameter that is of a layer of neurons and that corresponds to the bit. If a value of a bit in the second bit sequence is 0, the first apparatus is indicated not to send a local model parameter that is of a layer of neurons and that corresponds to the bit. It can be learned that the second apparatus may determine, based on the second bit sequence, that the part of the model parameters includes the local model parameter of the 1^{st} layer of neurons and the local model parameter of the 4^{th} layer of neurons.

Optionally, the P bits may be P elements in a second matrix, and the P elements are in one-to-one correspondence with the local model parameters of the P layers of neurons. One of the P elements indicates whether the first apparatus sends a local model parameter that is of a layer of neurons and that corresponds to the element. For example, the first model is a neural network model, and a dimension of the second matrix is determined based on a quantity of layers included in the neural network model. For example, the neural network model includes five layers of neurons. Therefore, the dimension of the second matrix is 5*1.

Implementation 3. All the local model parameters of the first model include local model parameters of P layers of neurons, and P is an integer greater than or equal to 1; and the first information includes a first flag bit and a layer sequence number of at least one first target layer in the P layers of neurons, and the first flag bit indicates that the first apparatus has not sent a local model parameter of a neuron of the at least one first target layer; or the first information includes a second flag bit and a layer sequence number of at least one second target layer in the P layers of neurons, and the second flag bit indicates that the first apparatus has sent a local model parameter of a neuron of the at least one second target layer.

For descriptions of related examples in Implementation 3, refer to related descriptions in Table 1 and Table 2 in the embodiment shown in FIG. 2. Details are not described herein again.

It should be noted that Implementation 2 and Implementation 3 each show an implementation in which the second apparatus indicates, by using the first information, whether the first apparatus sends a local model parameter of each of the P layers of neurons. In some embodiments, on this basis, for a to-be-sent local model parameter, the second apparatus may further indicate the first apparatus to send a specific to-be-sent local model parameter of a layer of neurons. This is not specifically limited in this disclosure. For example, the first information further includes third indication information, and the third indication information indicates whether the first apparatus sends each to-be-sent local model parameter of the layer of neurons.

Optionally, the embodiment shown in FIG. 7 further includes step 702a. Step 702a may be performed before step 702.

702a: The first apparatus trains the first model to obtain the part of the local model parameters of the first model.

In this implementation, the first apparatus determines the part of to-be-sent the local model parameters of the first model. The first apparatus calculates only the part of the local model parameters of the first model. The first apparatus may not calculate a local model parameter that is of the first model and that does not need to be sent. Therefore, a local calculation amount of the first apparatus is reduced, and an energy consumption loss of the first apparatus is reduced.

Optionally, the embodiment shown in FIG. 7 further includes step 701a and step 701b. Step 701a and step 701b may be performed before step 701.

701a: The second apparatus sends N global model parameters of the first model to the first apparatus. Correspondingly, the first apparatus receives the N global model parameters of the first model from the second apparatus.

701b: The first apparatus updates the first model based on the N global model parameters of the first model, to obtain an updated first model.

For a meaning of the global model parameter, refer to the foregoing related descriptions.

Optionally, based on step 701a and step 701b, step 702a specifically includes: The first apparatus trains the updated first model to obtain the part of the local model parameters of the first model.

It should be noted that there is no fixed sequence of performing step 701a, step 701b, step 702a, and step 701. Step 701a, step 701b, and step 702a may be performed before step 701; step 701 is performed before step 701a, step 701b, and step 702a; or step 701a, step 701b, step 702a, and step 701 are performed simultaneously based on a case. This is not specifically limited in this disclosure.

In this embodiment of this disclosure, the first apparatus determines the part of to-be-sent the local model parameters of the first model of the first apparatus. Then, the first apparatus sends the part of the local model parameters of the first model and the first information to the second apparatus. The first information indicates that the first apparatus has sent the part of the local model parameters of the first model. It can be learned that the first apparatus may send only the part of the local model parameters of the first model, and the first apparatus does not need to send all the local model parameters of the first model. Therefore, signaling overheads of sending the local model parameter of the first model by the first apparatus are reduced. In other words, a data volume of local model parameter transmission between apparatuses is greatly reduced, communication efficiency is improved, and energy consumed during the local model parameter transmission between the apparatuses is reduced, thereby achieving an energy saving effect.

It should be noted that step 701a and step 701b in the embodiment shown in FIG. 7 show a solution in which the second apparatus sends the N global model parameters of the first model to the first apparatus, and the first apparatus updates the first model based on the N global model parameters of the first model. In some embodiments, the second apparatus may send a part of the global model parameters of the first model to the first apparatus, and the first apparatus updates the first model based on the part of the global model parameters. A specific implementation process is similar to a process of step 801 to step 803 in the following embodiment shown in FIG. 8. For details, refer to related descriptions of step 801 to step 803 in the following embodiment shown in FIG. 8.

FIG. 8 is a diagram of a third embodiment of a communication method according to an embodiment of this disclosure. Refer to FIG. 8. The method includes the following steps.

801: A second apparatus sends a part of first global model parameters of a first model of a first apparatus to the first apparatus. Correspondingly, the first apparatus receives the part of the first global model parameters of the first model of the first apparatus from the second apparatus.

For a meaning of the global model parameter, refer to the foregoing related descriptions.

For example, in a federated learning process, the second apparatus obtains each first global model parameter of the first model of the first apparatus by aggregating local model parameters of a plurality of first apparatuses. Then, the second apparatus may select the part of the first global model parameters of the first model, and send the part of the first global model parameters of the first model to the first apparatus.

Optionally, all the first global model parameters of the first model include N first global model parameters obtained by the second apparatus by aggregating local model parameters of the plurality of apparatuses in an (M+1)^{th} round. N is an integer greater than or equal to 2. The N first global model parameters are in one-to-one correspondence with N second global model parameters, the N second global model parameters are obtained by the second apparatus by aggregating local model parameters of the plurality of apparatuses in an M^{th} round, and M is an integer greater than or equal to 1. In the part of the first global model parameters of the first model, a ratio of a variation between each first global model parameter and a second global model parameter corresponding to the first global model parameter to the second global model parameter is greater than a first ratio.

In other words, for each of the N first global model parameters, if a variation of the first global model parameter relative to a second global model parameter corresponding to the first global model parameter is relatively large, the second apparatus may send the first global model parameter to the first apparatus. If a variation of the first global model parameter relative to a second global model parameter corresponding to the first global model parameter is relatively small, the second apparatus may not send the first global model parameter.

Optionally, the first ratio may be 1/10 or 1/15. This is not specifically limited in this disclosure.

Optionally, a value of the first ratio may be set based on at least one of a size of a data sample, a type of the first model, and a capacity of the first model. The data sample refers to the local model parameters that are of the plurality of first apparatuses and that are collected by the second apparatus. For example, a larger capacity of the first model indicates a more complex first model, and the value of the first ratio may be relatively small. For example, if the data sample is abundant, the value of the first ratio may be relatively large.

802: The second apparatus sends first information to the first apparatus. The first information indicates that the second apparatus has sent the part of the first global model parameters of the first model. Correspondingly, the first apparatus receives the first information from the second apparatus.

The following describes three possible implementations of the first information. This disclosure is also applicable to another implementation. This is not specifically limited in this disclosure.

Implementation 1. All the first global model parameters of the first model include the N first global model parameters, and N is an integer greater than or equal to 2. The first information includes N pieces of first indication information, and the N pieces of first indication information are in one-to-one correspondence with the N first global model parameters. First indication information corresponding to each of the N first global model parameters indicates whether the second apparatus sends the first global model parameter.

Optionally, each of the N pieces of first indication information includes one bit. Therefore, the N pieces of first indication information include N bits. For example, if a value of one of the N pieces of first indication information is 1, the first indication information indicates that the second apparatus has sent a first global model parameter corresponding to the first indication information. If a value of one of the N pieces of first indication information is 0, the first indication information indicates that the second apparatus has not sent a first global model parameter corresponding to the first indication information. Alternatively, if a value of one of the N pieces of first indication information is 0, the first indication information indicates that the second apparatus has sent a first global model parameter corresponding to the first indication information. If a value of one of the N pieces of first indication information is 1, the first indication information indicates that the second apparatus has not sent a first global model parameter corresponding to the first indication information.

For example, the N first global model parameters include 10 first global model parameters: a first global model parameter 1 to a first global model parameter 10. The N bits form a first bit sequence. The first bit sequence is 0111001100. A 1^{st} bit corresponds to the first global model parameter 1, a 2^{nd} bit corresponds to the first global model parameter 2, the rest may be deduced by analogy, and a 10^{th} bit corresponds to the first global model parameter 10. If a value of a bit in the first bit sequence is 1, the second apparatus is indicated to send a first global model parameter corresponding to the bit. If a value of a bit in the first bit sequence is 0, it indicates that the second apparatus has sent a first global model parameter corresponding to the bit. It can be learned that the first apparatus may determine, based on the first bit sequence, that the part of the first global model parameters includes the first global model parameter 2 to the first global model parameter 4, the first global model parameter 7, and the first global model parameter 8.

Optionally, the N bits may be N elements in a first matrix. The N elements are in one-to-one correspondence with the N first global model parameters. One of the N elements indicates whether the second apparatus sends a first global model parameter corresponding to the element. For example, the first model is a neural network model, and a dimension of the first matrix is determined based on a quantity of layers included in the neural network model and a quantity of local model parameters included in each layer of neurons. The neural network model includes five layers of neurons, and each layer of neurons includes four local model parameters. Therefore, the dimension of the first matrix may be 5*4.

Implementation 2. All the first global model parameters of the first model include first global model parameters of P layers of neurons, P is an integer greater than or equal to 1, the first information includes P pieces of second indication information, the P pieces of second indication information are in one-to-one correspondence with the first global model parameters of the P layers of neurons, and second indication information corresponding to a first global model parameter of each of the P layers of neurons indicates whether the second apparatus sends the first global model parameter of each layer of neurons.

Optionally, each of the P pieces of second indication information includes one bit. Therefore, the P pieces of second indication information include P bits. For example, if a value of one of the P pieces of second indication information is 1, the second indication information indicates that the second apparatus has sent a first global model parameter that is of a layer of neurons and that corresponds to the second indication information. If a value of one of the P pieces of second indication information is 0, the second indication information indicates that the second apparatus has not sent a first global model parameter that is of a layer of neurons and that corresponds to the second indication information. Alternatively, if a value of one of the P pieces of second indication information is 0, the second indication information indicates that the second apparatus has sent a first global model parameter that is of a layer of neurons and that corresponds to the second indication information. If a value of one of the P pieces of second indication information is 1, the second indication information indicates that the second apparatus has not sent a first global model parameter that is of a layer of neurons and that corresponds to the second indication information.

For example, the first global model parameters of the P layers of neurons include first global model parameters of five layers of neurons. The P bits form a second bit sequence. The second bit sequence is 01110. A 1^{st} bit corresponds to a first global model parameter of a 1^{st} layer of neurons, a 2^{nd} bit corresponds to a first global model parameter of a 2^{nd} layer of neurons, the rest may be deduced by analogy, and a 5^{th} bit corresponds to a first global model parameter of a 5^{th} layer of neurons. If a value of a bit in the second bit sequence is 1, the second apparatus is indicated to send a first global model parameter that is of a layer of neurons and that corresponds to the bit. If a value of a bit in the second bit sequence is 0, the second apparatus is indicated not to send a first global model parameter that is of a layer of neurons and that corresponds to the bit. It can be learned that the first apparatus may determine, based on the second bit sequence, that the part of the first global model parameters includes the first global model parameter of the 2^{nd} layer of neurons, the first global model parameter of the 3^{rd} layer of neurons, and the first global model parameter of the 4^{th} layer of neurons.

Optionally, the P bits may be P elements in a second matrix, and the P elements are in one-to-one correspondence with the first global model parameters of the P layers of neurons. One of the P elements indicates whether the second apparatus sends a first global model parameter that is of a layer of neurons and that corresponds to the element. For example, the first model is a neural network model, and a dimension of the second matrix is determined based on a quantity of layers included in the neural network model. For example, the neural network model includes five layers of neurons. Therefore, the dimension of the second matrix is 5*1.

Implementation 3: All the first global model parameters of the first model include first global model parameters of P layers of neurons, and P is an integer greater than or equal to 1; and the first information includes a first flag bit and a layer sequence number of at least one first target layer in the P layers of neurons, and the first flag bit indicates that the second apparatus has not sent a first global model parameter of a neuron of the at least one first target layer; or the first information includes a second flag bit and a layer sequence number of at least one second target layer in the P layers of neurons, and the second flag bit indicates that the second apparatus has sent a first global model parameter of a neuron of the at least one second target layer.

For example, the P layers of neurons include eight layers of neurons. A layer sequence number of a 1^{st} layer is 1, a layer sequence number of a 2^{nd} layer is 2, the rest may be deduced by analogy, and a layer sequence number of an 8^{th} layer is 8. The first information includes content shown in Table 3. The at least one first target layer includes the 2^{nd} layer and the 4^{th} layer. Therefore, the first information includes the layer sequence number of the 2^{nd} layer and the layer sequence number of the 4^{th} layer that are shown in Table 3. A value of the first flag bit being 0 indicates the first apparatus not to send a first global model parameter of the 2^{nd} layer of neurons and a first global model parameter of the 4^{th} layer of neurons.

TABLE 3

| Layer sequence number | First flag bit |
|---|---|
| 2 | 0 |
| 4 | |

It can be learned that in a scenario in which there are a small quantity of first target layers, the second apparatus may send the first information in this implementation. Therefore, signaling overheads produced when the second apparatus sends the first information are reduced.

For example, the P layers of neurons include five layers of neurons. A layer sequence number of a 1^{st} layer is 1, a layer sequence number of a 2^{nd} layer is 2, the rest may be deduced by analogy, and a layer sequence number of a 5^{th} layer is 5. The first information includes content shown in Table 4. The at least one second target layer includes the 3^{rd} layer and the 4^{th} layer. Therefore, the first information includes the layer sequence number of the 3^{rd} layer, the layer sequence number of the 4^{th} layer, and the second flag bit that are shown in Table 4. A value of the second flag bit being 1 indicates the second apparatus to send a first global model parameter of the 3^{rd} layer of neurons and a first global model parameter of the 4^{th} layer of neurons.

TABLE 4

| Layer sequence number | second flag bit |
|---|---|
| 3 | 1 |
| 4 | |

It can be learned that in a scenario in which there are a small quantity of second target layers, the second apparatus may send the first information in this implementation. Therefore, signaling overheads produced when the second apparatus sends the first information are reduced.

It should be noted that Implementation 2 and Implementation 3 each show an implementation in which the second apparatus indicates, by using the first information, whether the first apparatus sends a first global model parameter of each of the P layers of neurons. In other words, the first information indicates a first global model parameter that is of a specific layer of neurons and that needs to be sent. In some embodiments, on this basis, the second apparatus may further indicate the second apparatus to send a specific first global model parameter that is indicated in the first information and that is of a layer of neurons that need to be sent. This is not specifically limited in this disclosure. For example, the first information further includes third indication information, and the third indication information indicates whether the second apparatus sends each to-be-sent first global model parameter of the layer of neurons.

In this implementation, different first apparatuses use same first information.

It should be noted that, optionally, there is no fixed sequence of performing step 801 and step 802. Step 801 may be performed before step 802; step 802 may be performed before step 801; or step 801 and step 802 are simultaneously performed based on a case. This is not specifically limited in this disclosure.

It should be noted that, optionally, the part of the first global model parameters and the first information may be carried in same signaling, or may be carried in different signaling.

803: The first apparatus updates the first model based on the first information and the part of the first global model parameters, to obtain an updated first model.

For example, the first information includes a first bit sequence. The first bit sequence is 0111001100. A 1^{st} bit corresponds to a first global model parameter 1, a 2^{nd} bit corresponds to a first global model parameter 2, the rest may be deduced by analogy, and a 10^{th} bit corresponds to a first global model parameter 10. If a value of a bit in the first bit sequence is 1, the second apparatus is indicated to send a first global model parameter corresponding to the bit. If a value of a bit in the first bit sequence is 0, it indicates that the second apparatus has sent a first global model parameter corresponding to the bit. It can be learned that the first apparatus may determine, based on the first bit sequence, that the part of the first global model parameters includes the first global model parameter 2 to the first global model parameter 4, the first global model parameter 7, and the first global model parameter 8. The first global model parameter 2 to the first global model parameter 4 respectively correspond to a neuron 1, a neuron 2, and a neuron 3. The first global model parameter 7 corresponds to a neuron 7. The first global model parameter 8 corresponds to a neuron 8. Therefore, the first apparatus may use the first global model parameter 2 as a global model parameter of the neuron 1, use the first global model parameter 3 as a global model parameter of the neuron 2, use the first global model parameter 4 as a global model parameter of the neuron 3, use the first global model parameter 7 as a global model parameter of the neuron 7, and use the first global model parameter 8 as a global model parameter of the neuron 8.

Optionally, the embodiment shown in FIG. 8 further includes step 804 and step 805. Step 804 and step 805 may be performed after step 803.

804: The first apparatus trains the updated first model to obtain a local model parameter.

805: The first apparatus sends the local model parameter of the first model to the second apparatus. Correspondingly, the second apparatus receives the local model parameter of the first model from the first apparatus.

In this embodiment of this disclosure, the first apparatus receives the part of the first global model parameters of the first model of the first apparatus from the second apparatus. The first apparatus receives the first information from the second apparatus, where the first information indicates that the second apparatus has sent the part of the first global model parameters. Then, the first apparatus updates the first model based on the first information and the part of the first global model parameters, to obtain the updated first model. It can be learned that the second apparatus may send only the part of the first global model parameters of the first model to the first apparatus, and does not need to send all the first global model parameters of the first model. Therefore, signaling overheads of sending the first global model parameter of the first model by the second apparatus are reduced. In other words, a data volume of global model parameter transmission between apparatuses is greatly reduced, communication efficiency is improved, and energy consumed during the global model parameter transmission between the apparatuses is reduced, thereby achieving an energy saving effect.

It should be noted that in the embodiment shown in FIG. 8, step 804 and step 805 show a solution in which the first apparatus trains the first model and sends the local model parameter of the first model to the second apparatus. In some embodiments, the first apparatus may send only the local model parameter of the first model to the second apparatus, to reduce overheads of sending the local model parameter by the first apparatus. For example, the first apparatus may receive, from the second apparatus, information indicating whether the first apparatus sends each local model parameter of the first model. Then, the first apparatus determines, based on the information, a part of to-be-sent local model parameters of the first model, and sends the part of the local model parameters to the second apparatus. The implementation process is similar to step 201 to step 203 in the embodiment shown in FIG. 2. For details, refer to related descriptions of step 201 to step 203 in the embodiment shown in FIG. 2. For another example, the first apparatus may autonomously determine a part of to-be-sent local model parameters of the first model. Then, the first apparatus sends, to the second apparatus, the part of the local model parameters and information indicating that the first apparatus has sent the part of the local model parameters. The implementation process is similar to step 701 to step 702 in the embodiment shown in FIG. 7. For details, refer to related descriptions of step 701 to step 702 in the embodiment shown in FIG. 7.

The following describes the first apparatus provided in an embodiment of this disclosure. FIG. 9 is a diagram of a structure of a first apparatus according to an embodiment of this disclosure. The first apparatus 900 may be configured to perform the steps performed by the first apparatus in the embodiments shown in FIG. 2, FIG. 7, and FIG. 8. For details, refer to related descriptions of the foregoing method embodiments.

The first apparatus 900 includes a transceiver module 901 and a processing module 902.

In a possible implementation, the first apparatus 900 specifically performs the following solution.

The transceiver module 901 is configured to receive first information from a second apparatus, where the first information indicates whether the first apparatus 900 sends each local model parameter of a first model of the first apparatus 900.

The processing module 902 is configured to determine a part of to-be-sent local model parameters of the first model based on the first information, where the part of the local model parameters is obtained by training the first model.

The transceiver module 901 is further configured to send the part of the local model parameters to the second apparatus.

Optionally, the local model parameter includes a local weight parameter of the first model.

Optionally, the local weight parameter includes a local weight or a local weight gradient of the first model.

Optionally, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus 900 sends the local model parameter.

Optionally, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus 900 sends the local model parameter.

Optionally, the transceiver module 901 is further configured to receive N global model parameters of the first model or global model parameters of the P layers of neurons of the first model from the second apparatus.

Optionally, the N global model parameters are in one-to-one correspondence with the N local model parameters; the N pieces of first indication information and the N global model parameters are carried in same signaling or different signaling; and when the N pieces of first indication information and the N global model parameters are carried in the same signaling, the N global model parameters and the N pieces of first indication information are arranged at intervals, and first indication information corresponding to each global model parameter is adjacently arranged after the global model parameter, or the N global model parameters are arranged before the N pieces of first indication information.

Optionally, the global model parameters of the P layers of neurons are in one-to-one correspondence with the local model parameters of the P layers of neurons; the P pieces of second indication information and the global model parameters of the P layers of neurons are carried in same signaling or different signaling; and when the P pieces of second indication information and the global model parameters of the P layers of neurons are carried in the same signaling, the global model parameters of the P layers of neurons and the P pieces of second indication information are arranged at intervals, and second indication information corresponding to a global model parameter of each layer of neurons is adjacently arranged after the global model parameter of each layer of neurons, or the global model parameters of the P layers of neurons are arranged before the P pieces of second indication information.

Optionally, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates the first apparatus 900 not to send a local model parameter of a neuron of the at least one first target layer; or the first information includes a second flag bit and a layer sequence number of at least one second target layer in the P layers of neurons, and the second flag bit indicates the first apparatus 900 to send a local model parameter of a neuron of the at least one second target layer.

In another possible implementation, the first apparatus 900 is specifically configured to perform the following solution.

The processing module 902 is configured to determine a part of to-be-sent local model parameters of a first model of the first apparatus 900, where the part of the local model parameters is obtained by training the first model.

The transceiver module 901 is configured to send the part of the local model parameters and first information to a second apparatus, where the first information indicates that the first apparatus 900 has sent the part of the local model parameters.

Optionally, the part of the local model parameters includes a local weight parameter of the first model.

Optionally, the local weight parameter includes a local weight or a local weight gradient of the first model.

Optionally, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus 900 sends the local model parameter.

Optionally, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus 900 sends the local model parameter of the layer of neurons.

Optionally, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates that the first apparatus 900 has not sent a local model parameter of a neuron of the at least one first target layer; or the first information includes a second flag bit and a layer sequence number of at least one second target layer in the P layers of neurons, and the second flag bit indicates the first apparatus 900 has sent a local model parameter of a neuron of the at least one second target layer.

Optionally, the processing module 902 is specifically configured to determine the part of the local model parameters based on at least one of the following: a local model parameter obtained by the first apparatus 900 by performing an R^{th} round of training on the first model, a status of a communication link on which the first apparatus 900 is located, and an operation capability of the first apparatus 900, where the part of the local model parameters is obtained by the first apparatus 900 by performing an (R+1)^{th} round of training on the first model, and R is an integer greater than or equal to 1.

In still another possible implementation, the first apparatus 900 is specifically configured to perform the following solution.

The transceiver module 901 is configured to: receive a part of first global model parameters of a first model of the first apparatus 900 from a second apparatus; and receive first information from the second apparatus, where the first information indicates that the second apparatus has sent the part of the first global model parameters.

The processing module 902 is configured to update the first model based on the first information and the part of the first global model parameters, to obtain an updated first model.

Optionally, the part of the first global model parameters includes a global weight parameter of the first model.

Optionally, the global weight parameter includes a global weight or a global weight gradient of the first model.

Optionally, all the first global model parameters of the first model include N first global model parameters, N is an integer greater than or equal to 2, the first information includes N pieces of first indication information, the N pieces of first indication information are in one-to-one correspondence with the N first global model parameters, and first indication information corresponding to each of the N first global model parameters indicates whether the second apparatus sends the first global model parameter.

Optionally, all the first global model parameters of the first model include first global model parameters of P layers of neurons, P is an integer greater than or equal to 1, the first information includes P pieces of second indication information, the P pieces of second indication information are in one-to-one correspondence with the first global model parameters of the P layers of neurons, and second indication information corresponding to a first global model parameter of each of the P layers of neurons indicates whether the second apparatus sends the first global model parameter of each layer of neurons.

Optionally, all the first global model parameters of the first model include first global model parameters of P layers of neurons, and P is an integer greater than or equal to 1; and
the first information includes a first flag bit and a layer sequence number of at least one first target layer in the P layers of neurons, and the first flag bit indicates that the second apparatus has not sent a first global model parameter of a neuron of the at least one first target layer; or
the first information includes a second flag bit and a layer sequence number of at least one second target layer in the P layers of neurons, and the second flag bit indicates that the second apparatus has sent a first global model parameter of a neuron of the at least one second target layer.

Optionally, all the first global model parameters of the first model include N first global model parameters obtained by the second apparatus by aggregating local model parameters of a plurality of apparatuses in an (M+1)^{th} round, and N is an integer greater than or equal to 2; the N first global model parameters are in one-to-one correspondence with N second global model parameters, the N second global model parameters are obtained by the second apparatus by aggregating local model parameters of the plurality of apparatuses in an M^{th} round, and M is an integer greater than or equal to 1; and in the part of the first global model parameters, a ratio of a variation between each first global model parameter and a second global model parameter corresponding to the first global model parameter to the second global model parameter is greater than a first ratio.

The following describes the second apparatus provided in an embodiment of this disclosure. FIG. 10 is a diagram of a structure of a second apparatus according to an embodiment of this disclosure. The second apparatus 1000 may be configured to perform the steps performed by the second apparatus in the embodiments shown in FIG. 2, FIG. 7, and FIG. 8. For details, refer to related descriptions of the foregoing method embodiments.

The second apparatus 1000 includes a transceiver module 1001. Optionally, the second apparatus 1000 further includes a processing module 1002.

In a possible implementation, the second apparatus 1000 is configured to perform the following solution.

The transceiver module 1001 is configured to: send first information to a first apparatus, where the first information indicates whether the first apparatus sends each local model parameter of a first model of the first apparatus; and receive a part of local model parameters of the first model from the first apparatus, where the part of the local model parameters is obtained by training the first model.

Optionally, the local model parameter includes a local weight parameter of the first model.

Optionally, the local weight parameter includes a local weight or a local weight gradient of the first model.

Optionally, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus sends the local model parameter.

Optionally, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter.

Optionally, the transceiver module 1001 is further configured to send N global model parameters of the first model or global model parameters of the P layers of neurons of the first model to the first apparatus.

Optionally, the N global model parameters are in one-to-one correspondence with the N local model parameters; the N pieces of first indication information and the N global model parameters are carried in same signaling or different signaling; and when the N pieces of first indication information and the N global model parameters are carried in the same signaling, the N global model parameters and the N pieces of first indication information are arranged at intervals, and first indication information corresponding to each global model parameter is adjacently arranged after the global model parameter, or the N global model parameters are arranged before the N pieces of first indication information.

Optionally, the global model parameters of the P layers of neurons are in one-to-one correspondence with the local model parameters of the P layers of neurons; the P pieces of second indication information and the global model parameters of the P layers of neurons are carried in same signaling or different signaling; and when the P pieces of second indication information and the global model parameters of the P layers of neurons are carried in the same signaling, the global model parameters of the P layers of neurons and the P pieces of second indication information are arranged at intervals, and second indication information corresponding to a global model parameter of each layer of neurons is adjacently arranged after the global model parameter of each layer of neurons, or the global model parameters of the P layers of neurons are arranged before the P pieces of second indication information.

Optionally, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates the first apparatus not to send a local model parameter of a neuron of the at least one first target layer; or the first information includes a second flag bit and a layer sequence number of at least one second target layer in the P layers of neurons, and the second flag bit indicates the first apparatus to send a local model parameter of a neuron of the at least one second target layer.

In another possible implementation, the second apparatus 1000 is configured to perform the following solution.

The transceiver module 1001 is configured to receive a part of local model parameters of a first model and first information from a first apparatus, where the first information indicates that the first apparatus has sent the part of the local model parameters, and the part of the local model parameters is obtained by training the first model.

The processing module 1002 is configured to determine the part of the local model parameters based on the first information.

Optionally, the part of the local model parameters includes a local weight parameter of the first model.

Optionally, the local weight parameter includes a local weight or a local weight gradient of the first model.

Optionally, all the local model parameters of the first model include N local model parameters, N is an integer greater than or equal to 2, the first information includes N pieces of first indication information, the N pieces of first indication information are in one-to-one correspondence with the N local model parameters, and first indication information corresponding to each of the N local model parameters indicates whether the first apparatus sends the local model parameter.

Optionally, all the local model parameters of the first model include local model parameters of P layers of neurons, P is an integer greater than or equal to 1, the first information includes P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter of the layer of neurons.

Optionally, all the local model parameters of the first model include local model parameters of P layers of neurons, and P is an integer greater than or equal to 1; and the first information includes a first flag bit and a layer sequence number of at least one first target layer in the P layers of neurons, and the first flag bit indicates that the first apparatus has not sent a local model parameter of a neuron of the at least one first target layer; or the first information includes a second flag bit and a layer sequence number of at least one second target layer in the P layers of neurons, and the second flag bit indicates that the first apparatus has sent a local model parameter of a neuron of the at least one second target layer.

In still another possible implementation, the second apparatus 1000 is configured to perform the following solution.

The transceiver module 1001 is configured to: send a part of first global model parameters of a first model of a first apparatus to the first apparatus; and send first information to the first apparatus, where the first information indicates that the second apparatus 1000 has sent the part of the first global model parameters.

Optionally, the part of the first global model parameters includes a global weight parameter of the first model.

Optionally, the global weight parameter includes a global weight or a global weight gradient of the first model.

Optionally, all the first global model parameters of the first model include N first global model parameters, N is an integer greater than or equal to 2, the first information includes N pieces of first indication information, the N pieces of first indication information are in one-to-one correspondence with the N first global model parameters, and first indication information corresponding to each of the N first global model parameters indicates whether the second apparatus 1000 sends the first global model parameter.

Optionally, all the first global model parameters of the first model include first global model parameters of P layers of neurons, P is an integer greater than or equal to 1, the first information includes P pieces of second indication information, the P pieces of second indication information are in one-to-one correspondence with the first global model parameters of the P layers of neurons, and second indication information corresponding to a first global model parameter of each of the P layers of neurons indicates whether the second apparatus 1000 sends the first global model parameter of each layer of neurons.

Optionally, all the first global model parameters of the first model include first global model parameters of P layers of neurons, and P is an integer greater than or equal to 1; and
the first information includes a first flag bit and a layer sequence number of at least one first target layer in the P layers of neurons, and the first flag bit indicates that the second apparatus 1000 has not sent a first global model parameter of a neuron of the at least one first target layer; or
the first information includes a second flag bit and a layer sequence number of at least one second target layer in the P layers of neurons, and the second flag bit indicates that the second apparatus 1000 has sent a first global model parameter of a neuron of the at least one second target layer.

Optionally, all the first global model parameters of the first model include N first global model parameters obtained by the second apparatus 1000 by aggregating local model parameters of a plurality of apparatuses in an (M+1)^{th} round, and N is an integer greater than or equal to 2; the N first global model parameters are in one-to-one correspondence with N second global model parameters, the N second global model parameters are obtained by the second apparatus 1000 by aggregating local model parameters of the plurality of apparatuses in an M^{th} round, and M is an integer greater than or equal to 1; and in the part of the first global model parameters, a ratio of a variation between each first global model parameter and a second global model parameter corresponding to the first global model parameter to the second global model parameter is greater than a first ratio.

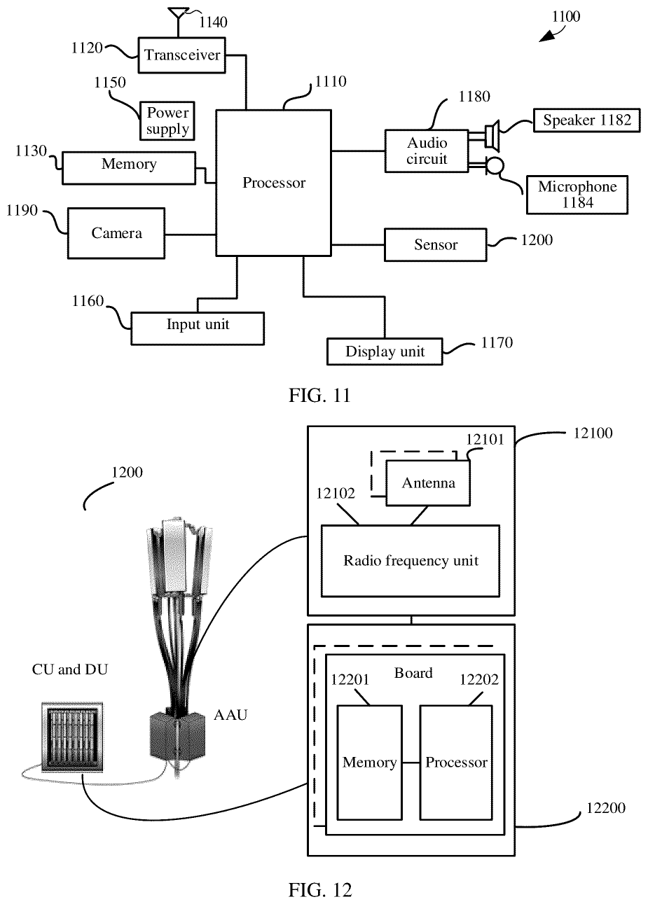

An embodiment of this disclosure further provides a terminal device. FIG. 11 is a diagram of a structure of a terminal device 1100 according to an embodiment of this disclosure. The terminal device 1100 may be used in the system shown in FIG. 1. For example, the terminal device 1100 may be the terminal device in the system in FIG. 1, and is configured to implement a function of the first apparatus in the foregoing method embodiments.

As shown in the figure, the terminal device 1100 includes a processor 1110 and a transceiver 1120. Optionally, the terminal device 1100 further includes a memory 1130. The processor 1110, the transceiver 1120, and the memory 1130 may communicate with each other through an internal connection path, to transfer a control signal and/or a data signal. The memory 1130 is configured to store a computer program. The processor 1110 is configured to: invoke the computer program from the memory 1130, and run the computer program, to control the transceiver 1120 to receive and send a signal. Optionally, the terminal device 1100 may further include an antenna 1140, configured to send, via a radio signal, uplink data or uplink control signaling output by the transceiver 1120.

The processor 1110 and the memory 1130 may be integrated into one processing apparatus. The processor 1110 is configured to execute program code stored in the memory 1130 to implement the foregoing functions. During specific implementation, the memory 1130 may alternatively be integrated into the processor 1110, or may be independent of the processor 1110. For example, the processor 1110 may correspond to the processing module 902 in FIG. 9.

The transceiver 1120 may correspond to the transceiver module 901 in FIG. 9. The transceiver 1120 may also be referred to as a transceiver unit. The transceiver 1120 may include a receiver (or referred to as a receiver machine or a receiver circuit) and a transmitter (or referred to as a transmitter machine or a transmitter circuit). The receiver is configured to receive a signal, and the transmitter is configured to transmit a signal.

It should be understood that the terminal device 1100 shown in FIG. 11 can implement the processes related to the first apparatus in the method embodiments shown in FIG. 2, FIG. 7, and FIG. 8. Operations and/or functions of the modules in the terminal device 1100 are separately intended to implement corresponding procedures in the foregoing apparatus embodiments. For details, refer to the descriptions in the foregoing apparatus embodiments. To avoid repetition, detailed descriptions are appropriately omitted herein.

The processor 1110 may be configured to perform an action that is implemented inside the first apparatus and that is described in the foregoing apparatus embodiments, and the transceiver 1120 may be configured to perform receiving and sending actions that are of the first apparatus and that are described in the foregoing apparatus embodiments. For details, refer to the descriptions in the foregoing apparatus embodiments. Details are not described herein again.

Optionally, the terminal device 1100 may further include a power supply 1150, configured to supply power to various components or circuits in the terminal device.

In addition, to improve functions of the terminal device, the terminal device 1100 may further include one or more of an input unit 1160, a display unit 1170, an audio circuit 1180, a camera 1190, a sensor 1200, and the like, and the audio circuit may further include a speaker 1182, a microphone 1184, and the like.

This disclosure further provides a network device. FIG. 12 is a diagram of a structure of a network device 1200 according to an embodiment of this disclosure. The network device 1200 may be used in the system shown in FIG. 1. For example, the network device 1200 may be the access network device or the core network device in the system shown in FIG. 1, to implement a function of the second apparatus in the foregoing method embodiments. It should be understood that the following is merely an example. In a future communication system, the network device may have another form and composition.

For example, in a 5G communication system, the network device 1200 may include a CU, a DU, and an AAU. In comparison with a network device that is in an LTE communication system and that includes one or more radio frequency units, for example, a remote radio unit (RRU) and one or more baseband units (BBUs),
a non-real-time part of the original BBU is split off and redefined as the CU, which is responsible for processing a non-real-time protocol and service, some physical layer processing functions of the BBU are combined with the original RRU and a passive antenna into the AAU, and remaining functions of the BBU are redefined as the DU, which is responsible for processing a physical layer protocol and a real-time service. In short, the CU and the DU are distinguished based on real-time performance of processed content, and the AAU is a combination of the RRU and the antenna.

The CU, the DU, and the AAU may be deployed separately or together. Therefore, there may be a plurality of network deployment forms. A possible deployment form, as shown in FIG. 12, is consistent with that of a conventional 4G network device. The CU and the DU are deployed on same hardware. FIG. 12 is merely an example, and constitutes no limitation on the protection scope of this disclosure. For example, a deployment form may alternatively be that DUs are deployed in a BBU equipment room, CUs or DUs are deployed together, or CUs are centralized at a higher level.

An AAU 12100 may implement receiving and sending functions, is referred to as a transceiver unit 12100, and corresponds to the transceiver module 1001 in FIG. 10. Optionally, the transceiver unit 12100 may also be referred to as a transceiver machine, a transceiver circuit, a transceiver, or the like, and may include at least one antenna 12101 and a radio frequency unit 12102. Optionally, the transceiver unit 12100 may include a receiving unit and a sending unit. The receiving unit may correspond to a receiver (or referred to as a receiver machine or a receiver circuit), and the sending unit may correspond to a transmitter (or referred to as a transmitter machine or a transmitter circuit).

A CU and DU 12200 may implement an internal processing function, is referred to as a processing unit 12200, and corresponds to the processing module 1002 in FIG. 10. Optionally, the processing unit 12200 may control the network device or the like, and may be referred to as a controller. The AAU, the CU, and the DU may be physically arranged together, or may be physically arranged separately.

In addition, the network device is not limited to the form shown in FIG. 12, and may alternatively be in another form. For example, the network device includes a BBU and an adaptive radio unit (ARU), or includes a BBU and an active antenna unit (AAU); may be a customer premises equipment (CPE); or may be in another form. This is not limited in this application.

In an example, the processing unit 12200 may include one or more boards. A plurality of boards may jointly support a radio access network (such as an LTE network) of a single access standard, or may separately support radio access networks (such as an LTE network, a 5G network, a future network, or another network) of different access standards. The CU and DU 12200 further includes a memory 12201 and a processor 12202. The memory 12201 is configured to store necessary instructions and data. The processor 12202 is configured to control the network device to perform a necessary action, for example, is configured to control the network device to perform an operation procedure related to the second apparatus in the foregoing method embodiments. The memory 12201 and the processor 12202 may serve the one or more boards. In other words, a memory and a processor may be disposed on each board. Alternatively, the plurality of boards may share a same memory and a same processor. In addition, a necessary circuit may further be disposed on each board.

The network device 1200 shown in FIG. 12 can implement functions of the second apparatus in the method embodiments in FIG. 2, FIG. 7, and FIG. 8. Operations and/or functions of units in the network device 1200 are separately intended to implement corresponding procedures performed by the network device in the foregoing method embodiments of this disclosure. To avoid repetition, detailed descriptions are appropriately omitted herein. The structure of the network device shown in FIG. 12 is merely a possible form, and should not constitute any limitation on embodiments of this disclosure. This disclosure does not exclude a possibility that there may be a network device structure in another form in the future.

The CU and DU 12200 may be configured to perform an action that is implemented inside the second apparatus and that is described in the foregoing method embodiments, and the AAU 12100 may be configured to perform receiving and sending actions that are of the second apparatus and that are described in the foregoing method embodiments. For details, refer to the descriptions in the foregoing method embodiments. Details are not described herein again.

This disclosure further provides a computer program product. The computer program product includes computer program code. When the computer program code is run on a computer, the computer is enabled to perform the method in any one of the embodiments shown in FIG. 2, FIG. 7, and FIG. 8.

This disclosure further provides a computer-readable medium. The computer-readable medium stores program code. When the program code is run on a computer, the computer is enabled to perform the method in any one of the embodiments shown in FIG. 2, FIG. 7, and FIG. 8.

This disclosure further provides a communication system. The communication system includes a first apparatus and a second apparatus. The first apparatus is configured to perform a part of or all steps performed by the first apparatus in the embodiments shown in FIG. 2, FIG. 7, and FIG. 8, and the second apparatus is configured to perform a part of or all steps performed by the second apparatus in the embodiments shown in FIG. 2, FIG. 7, and FIG. 8.

An embodiment of this disclosure further provides a chip apparatus including a processor configured to invoke a computer program or computer instructions stored in a memory, so that the processor performs the methods in the embodiments shown in FIG. 2, FIG. 7, and FIG. 8.

In a possible implementation, an input of the chip apparatus corresponds to the receiving operation in the embodiments shown in FIG. 2, FIG. 7, and FIG. 8, and an output of the chip apparatus corresponds to the sending operation in the embodiments shown in FIG. 2, FIG. 7, and FIG. 8.

Optionally, the processor is coupled to the memory through an interface.

Optionally, the chip apparatus further includes the memory, and the memory stores the computer program or the computer instructions.

The processor mentioned in any of the foregoing may be a genera-purpose central processing unit, a microprocessor, an application-specific integrated circuit (ASIC), or one or more integrated circuits configured to control program execution of the methods in the embodiments shown in FIG. 2, FIG. 7, and FIG. 8. The memory mentioned in any one of the foregoing may be a read-only memory (ROM), another type of static storage device that can store static information and instructions, a random access memory (RAM), or the like.

It can be clearly understood by persons skilled in the art that, for convenient and brief description, for explanations and beneficial effects of related content in any one of the communication apparatuses provided above, refer to the corresponding method embodiments provided above. Details are not described herein again.

In the several embodiments provided in this disclosure, the disclosed system, apparatus, and method may be implemented in other manners. For example, the described apparatus embodiments are merely examples. For example, division into the units is merely logical function division. There may be another division manner during actual implementation. For example, a plurality of units or components may be combined or integrated into another system, or some features may be ignored or not performed. In addition, the displayed or discussed mutual couplings, direct couplings, or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this disclosure essentially, or the part contributing to the conventional technology, or all or some of the technical solutions may be implemented in the form of a software product. The computer software product is stored in a storage medium and includes several instructions for instructing a computer device (which may be a personal computer, a server, or a network device) to perform all or some of the steps of the methods described in embodiments of this disclosure. The foregoing storage medium includes any medium that can store program code, such as a USB flash drive, a removable hard disk, a ROM, a RAM, a magnetic disk, or an optical disc.

In conclusion, the foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this disclosure.

What claimed is:

1. A communication method, wherein the method comprises:
receiving, by a first apparatus, first information from a second apparatus, wherein the first information indicates whether the first apparatus sends each local model parameter of a first model of the first apparatus;
determining, by the first apparatus, a part of to-be-sent local model parameters of the first model based on the first information, wherein the part of the local model parameters is obtained by training the first model; and
sending, by the first apparatus, the part of the local model parameters to the second apparatus.

2. The method according to claim 1, wherein the local model parameter comprises a local weight parameter of the first model.

3. The method according to claim 2, wherein the local weight parameter comprises a local weight or a local weight gradient of the first model.

4. The method according to claim 1, wherein all the local model parameters of the first model comprise N local model parameters, N is an integer greater than or equal to 2, the first information comprises N pieces of first indication information, the N pieces of first indication information are in one-to-one correspondence with the N local model parameters, and first indication information corresponding to each of the N local model parameters indicates whether the first apparatus sends the local model parameter.

5. The method according to claim 1, wherein all the local model parameters of the first model comprise local model parameters of P layers of neurons, P is an integer greater than or equal to 1, the first information comprises P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter.

6. The method according to claim 5, further comprising:
receiving, by the first apparatus, N global model parameters of the first model or global model parameters of the P layers of neurons of the first model from the second apparatus.

7. A communication method comprising:
determining, by a first apparatus, a part of to-be-sent local model parameters of a first model of the first apparatus, wherein the part of the local model parameters is obtained by training the first model; and
sending, by the first apparatus, the part of the local model parameters and first information to a second apparatus, wherein the first information indicates that the first apparatus has sent the part of the local model parameters.

8. The method according to claim 7, wherein the part of the local model parameters comprises a local weight parameter of the first model.

9. The method according to claim 8, wherein the local weight parameter comprises a local weight or a local weight gradient of the first model.

10. The method according to claim 7, wherein all the local model parameters of the first model comprise N local model parameters, N is an integer greater than or equal to 2, the first information comprises N pieces of first indication information, the N pieces of first indication information are in one-to-one correspondence with the N local model parameters, and first indication information corresponding to each of the N local model parameters indicates whether the first apparatus sends the local model parameter.

11. The method according to claim 7, wherein all the local model parameters of the first model comprise local model parameters of P layers of neurons, P is an integer greater than or equal to 1, the first information comprises P pieces of second indication information, the P pieces of second indication information are in one-to-one correspondence with the local model parameters of the P layers of neurons, and second indication information corresponding to a local model parameter of each of the P layers of neurons indicates whether the first apparatus sends the local model parameter of each layer of neurons.

12. The method according to claim 7, wherein all the local model parameters of the first model comprise local model parameters of P layers of neurons, and P is an integer greater than or equal to 1; and
the first information comprises a first flag bit and a layer sequence number of at least one first target layer in the P layers of neurons, and the first flag bit indicates that the first apparatus has not sent a local model parameter of a neuron of the at least one first target layer.

13. The method according to claim 7, wherein the first information comprises a second flag bit and a layer sequence number of at least one second target layer in the P layers of neurons, and the second flag bit indicates that the first apparatus has sent a local model parameter of a neuron of the at least one second target layer.

14. The method according to claim 7, wherein determining, by the first apparatus, the part of to-be-sent local model parameters of the first model of the first apparatus comprises:
determining, by the first apparatus, the part of the local model parameters based on at least one of the following: a local model parameter obtained by the first apparatus by performing an R^{th} round of training on the first model, a status of a communication link on which the first apparatus is located, and an operation capability of the first apparatus, wherein the part of the local model parameters is obtained by the first apparatus by performing an (R+1)^{th} round of training on the first model, and R is an integer greater than or equal to 1.

15. A communication method comprising:
sending, by a second apparatus, a part of first global model parameters of a first model of a first apparatus to the first apparatus; and
sending, by the second apparatus, first information to the first apparatus, wherein the first information indicates that the second apparatus has sent the part of the first global model parameters.

16. The method according to claim 15, wherein the part of the first global model parameters comprises a global weight parameter of the first model.

17. The method according to claim 16, wherein the global weight parameter comprises a global weight or a global weight gradient of the first model.

18. The method according to claim 15, wherein all the first global model parameters of the first model comprise N first global model parameters, N is an integer greater than or equal to 2, the first information comprises N pieces of first indication information, the N pieces of first indication information are in one-to-one correspondence with the N first global model parameters, and first indication information corresponding to each of the N first global model parameters indicates whether the second apparatus sends the first global model parameter.

19. The method according to claim 15, wherein all the first global model parameters of the first model comprise first global model parameters of P layers of neurons, P is an integer greater than or equal to 1, the first information comprises P pieces of second indication information, the P pieces of second indication information are in one-to-one correspondence with the first global model parameters of the P layers of neurons, and second indication information corresponding to a first global model parameter of each of the P layers of neurons indicates whether the second apparatus sends the first global model parameter of each layer of neurons.

20. The method according to claim 15, wherein all the first global model parameters of the first model comprise first global model parameters of P layers of neurons, and P is an integer greater than or equal to 1; and
the first information comprises a first flag bit and a layer sequence number of at least one first target layer in the P layers of neurons, and the first flag bit indicates that the second apparatus has not sent a first global model parameter of a neuron of the at least one first target layer; or
the first information comprises a second flag bit and a layer sequence number of at least one second target layer in the P layers of neurons, and the second flag bit indicates that the second apparatus has sent a first global model parameter of a neuron of the at least one second target layer.
